(19) United States
(12) Patent Application Publication
(10) Pub. No.: US 2016/0149519 A1
(43) Pub. Date: May 26, 2016

(54) ELECTROHYDRODYNAMIC SYSTEM AND METHOD OF OPERATION

(71) Applicant: Accio Energy, Inc., Ann Arbor, MI (US)

(72) Inventors: Randy Stevenson, Ann Arbor, MI (US); Dawn White, Ann Arbor, MI (US); Joseph McElroy, Ann Arbor, MI (US); Francis Mills, Ann Arbor, MI (US); Mike Bosserman, Ann Arbor, MI (US); Vladimir Orlyanchik, Ann Arbor, MI (US)

(21) Appl. No.: 14/952,713

(22) Filed: Nov. 25, 2015

Related U.S. Application Data
(60) Provisional application No. 62/084,035, filed on Nov. 25, 2014.
(60) Provisional application No. 62/101,920, filed on Jan. 9, 2015.

(51) Int. Cl. H02N 3/00

(52) U.S. Cl. CPC H02N 3/00

(57) ABSTRACT

An electrohydrodynamic system configured to harvest electrical energy from a wind stream flowing along a wind vector, including: a charged droplet generator configured to generate a first electric field, the charged droplet generator including: a manifold, a plurality of channels extending through the manifold thickness along a downstream face of the manifold, and a field shaper configured to generate a substantially uniform charging field proximal the plurality of channels that charges the droplets to a single polarity, wherein the first electric field opposes charged droplet movement along the wind vector.

### CROSS-REFERENCE TO RELATED APPLICATIONS

This application claims the benefit of U.S. Provisional Application No. 62/084,035, filed 25 Nov. 2014, and U.S. Provisional Application No. 62/101,920, filed 9 Jan. 2015, which are incorporated in their entireties by this reference.

### TECHNICAL FIELD

This invention relates generally to the electro-hydrodynamic wind energy conversion field, and more specifically to a new and useful system in the electro-hydrodynamic wind energy conversion field.

### BRIEF DESCRIPTION OF THE FIGURES

FIG. 1 is a schematic representation of an EHD system and EHD system operation.

FIG. 2 is a schematic representation of a variation of the EHD system.

FIGS. 3A, 3B, and 3C are an isometric view of a first variation of the manifold, a cross sectional view of the manifold, and a close-up view of the channels, respectively.

FIGS. 4A, 4B, 4C, 4D, and 4E are: an isometric view of a second variation of the manifold, including channels and an auxiliary component; a cross sectional view of the manifold; a first variation of second manifold variant construction; a second variation of second manifold variant construction; and a third variation of second manifold variant construction, respectively.

FIGS. 5A, 5B, 5C, and 5D are: an exploded view of a multi-layer variation of the manifold including channels, an intermediate layer, and an auxiliary component; a cross sectional view of a first variant of the multi-layer construction; a cross sectional view of a second variant of the multi-layer construction; and a cross sectional view of a third variant of the multi-layer construction, respectively.

FIGS. 6A and 6B are an isometric view of a third variation of the manifold and a cross sectional view of the manifold, respectively.

FIGS. 7A and 7B are an isometric view of a fourth variation of the manifold, wherein the manifold is locally thinned about the second channel ends, and a cross sectional view of the manifold, respectively.

FIGS. 8A, 8B, 8C, and 8D are cross sectional views of a first, second, third, and fourth variant of the leading edge feature, respectively.

FIGS. 9A, 9B, and 9C are cross sectional views of a first, second, and third variant of the trailing edge feature, respectively.

FIGS. 10A, 10B, and 10C are cross sectional views of a first, second, and third variant of manifold cross-section, respectively.

FIGS. 11A, 11B, and 11C are cross sectional views of a first, second, and third variant of the channel, respectively.

FIG. 12 is a schematic representation of a variant of the manifold including guard channels.

FIG. 13 is a schematic representation of a variant of the manifold including guard protrusions.

FIG. 14 is a schematic representation of a variant of charged droplet generation.

FIG. 15 is a schematic representation of a variant of channel orientation relative to the fluid stream.

FIG. 16 is a schematic representation of a variant of the charged particle generator including multiple manifolds and secondary electrodes.

FIG. 17 is a schematic representation of a variant of field shaper orientation relative to the manifold.

FIG. 18 is a specific example of an offshore EHD system.

FIG. 19 is a schematic representation of serial reservoir operation.

FIGS. 20A and 20B are lateral cross-sections of a first and second arrangement variant of the manifold relative to field shaper(s), respectively.

FIG. 21 is a schematic representation of a longitudinal cross section of a variation of the field shaper.

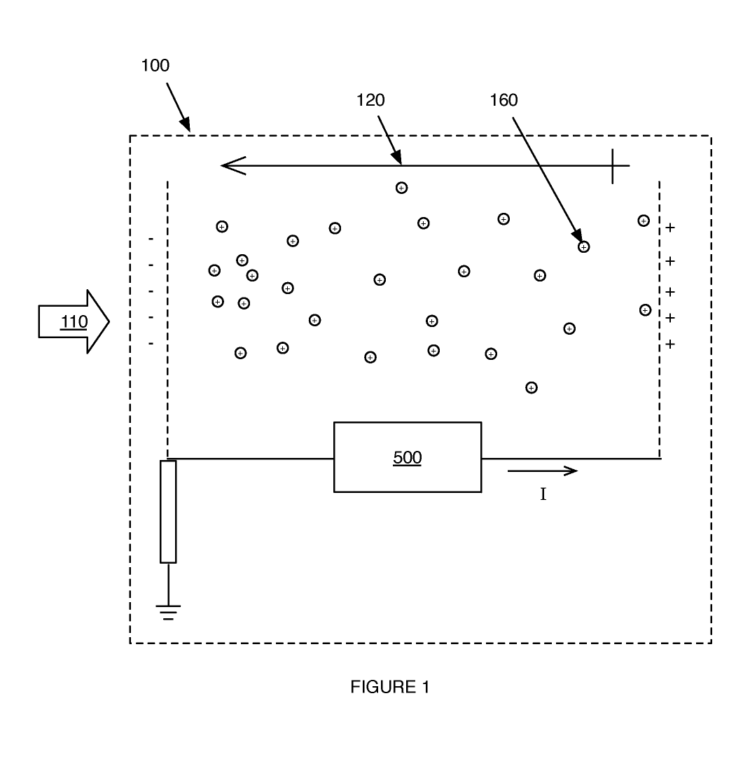

### DESCRIPTION OF THE PREFERRED EMBODIMENTS

The following description of the preferred embodiments of the invention is not intended to limit the invention to these preferred embodiments but rather to enable any person skilled in the art to make and use this invention.

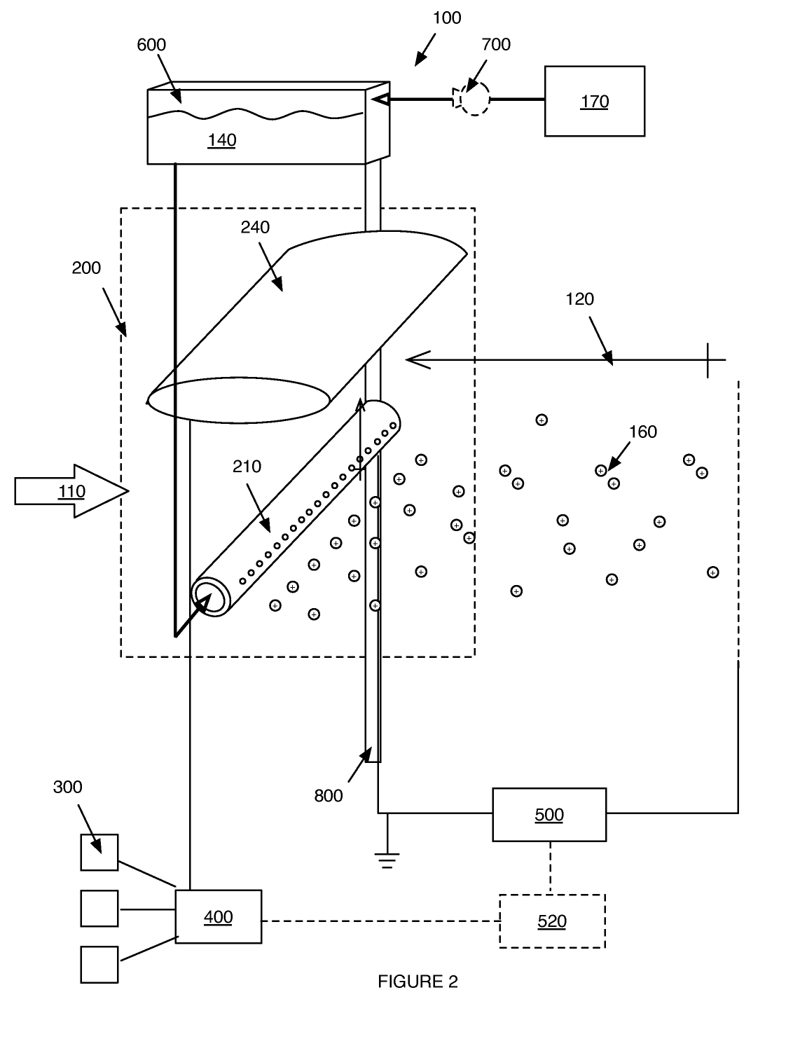

As shown in FIG. 2, the electro-hydrodynamic (EHD) system 100 includes a charged particle generator 200 including: a manifold 210, a channel 220, and a field shaper 240. The EHD system 100 can additionally include: a sensor 300, a controller 400, an electrical load 500, a reservoir 600, an upstream collector, and/or a downstream collector. The EHD system 100 functions to convert kinetic energy from a fluid stream 110 flowing past the EHD system 100 into electrical energy.

In operation, the EHD system 100 can polarize a carrier fluid 140 (which serves as the charge source) and break up a jet of charged liquid into discretized droplets (a process called dropletization). In one variation, the EHD system 100 can dropletize the carrier fluid 140 by pump 700ing a pressurized, polarizable carrier liquid through an aperture 229, (e.g., wherein the carrier liquid can dropletize due to Plateau-Rayleigh instability or another instability). The droplets can be charged by virtue of immersion in an external electrostatic field during dropletization. The charged droplets 160 can be charged to a single polarity (e.g., positive or negative), and released into the fluid stream 110 against an applied electric field, wherein the electric field opposes charged droplet 160 movement with the wind. The kinetic energy of the fluid stream 110 performs electrical work on charged droplets 160 as they move against the applied electric field (working electric field). This separates the charged droplets 160 from their oppositely-charged counterparts, which remain at the charged particle generator 200. This movement also increases the droplets' potential energy. Upon connection of an electrical load 500 between the charged particle generator 200 and a downstream point, electric energy can be extracted from the resultant charge separation, thereby converting the fluid stream's 110 kinetic energy into electric energy. In one variation, the EHD system 100 can operate in a similar manner and include components that are substantially similar to the EHD system 100 disclosed in U.S. application Ser. No. 14/299,970 filed 9 Jun. 2014, which is incorporated herein in its entirety by this reference. However, the EHD system 100 can operate in any other suitable manner, and include any other suitable set of components.

The EHD system 100 can be used in wave applications (e.g., offshore applications), urban applications (e.g., on the roof of a building), terrestrial applications (e.g., wind corridors, mountaintop applications, etc.), aerial applications (e.g., wherein the EHD system 100 can be mounted to a plane or kite), or in any other suitable application.

The EHD system 100 is preferably used with a fluid stream 110, which functions to carry the charged particles against the applied electric field. The fluid stream 110 can flow along a fluid vector at a flow velocity. The fluid stream 110 is preferably a wind stream, but can alternatively be a liquid stream or any other suitable fluid stream 110. The fluid stream 110 is preferably a naturally-occurring fluid stream 110, but can alternatively be induced by a secondary system (e.g., a waste stream from an industrial process) or otherwise generated.

The EHD system 100 is preferably used with a carrier fluid 140, which functions as a carrier for the charged particles. The carrier fluid 140 can additionally function to provide additional mass to the charges of the first polarity, such that inertia from the fluid stream 110 overcomes the electric field gradient. The carrier fluid 140 is preferably electrically conductive, but can alternatively be electrically non-conductive. The carrier fluid 140 can optionally include electrically conductive solutes (e.g., salt) or any other suitable additive (e.g., fertilizer). The carrier fluid 140 is preferably polar and ionizable, but can alternatively be substantially non-polar or have any other suitable properties. The carrier fluid 140 can be a liquid, gas, or any other suitable fluid. The carrier fluid 140 is preferably denser than the fluid of the fluid stream 110, but can alternatively have any other suitable property relative to the fluid stream no. Examples of the carrier fluid 140 can include rainwater, recycled water, seawater, oil, fertilizer, or any other suitable fluid.

The carrier fluid 140 is preferably supplied from a carrier fluid source 170 to the EHD system 100, but can alternatively be otherwise supplied. Within the EHD system 100, the carrier fluid 140 is preferably retained within the reservoir 600 (e.g., prior to charging and/or supply to the manifold 210), but can alternatively be otherwise retained. The carrier fluid source 170 can be the ambient environment, a user-supplied fluid source (e.g., a canister or a secondary reservoir 600), or be any other suitable fluid source. In a first variation, the carrier fluid 140 is pumped from the ambient environment. In a specific example, when the EHD system 100 is adjacent to water waves (e.g., in the ocean), the carrier fluid source 170 can be the ocean. In this specific example, the system can additionally leverage wave energy (e.g., using a wave pump 710) to pump carrier fluid 140 (e.g., seawater) to the EHD system 100. In a second variation, the carrier fluid 140 is collected from the ambient environment (e.g., collected rainwater, etc.). However, the carrier fluid 140 can be otherwise supplied.

### 1. Benefits.

This EHD system 100 can confer several benefits over conventional EHD system 100.

First, by consuming less energy, the EHD system 100 directly realizes improved efficiency over preexisting systems. In particular, this charged particle generator 200 can function with lower operating fluid pressures, which enables the EHD system 100 to minimize energy spent on pressurizing the carrier fluid 140. Furthermore, because these low operating pressures are within the pressure range that can be reasonably supplied by hydrostatic pressure, some variants of the system can additionally minimize carrier fluid 140 pressurization energy expenditure by elevating the reservoir 600 above the charged particle generator 200 and gravity-feeding the carrier fluid 140 to the charged particle generator 200. This can be particularly useful in applications where the carrier fluid 140 is harvested from the ambient environment (e.g., when the carrier fluid 140 is rainwater), or when the carrier fluid 140 is pumped to the reservoir 600 and retained for a period of time. Additionally, in offshore applications where the EHD system 100 is proximate water waves, the system can further minimize energy expenditure by leveraging a wave pump 710 to pump the carrier fluid 140 to the reservoir 600.

Second, by optimizing the density of charged droplets 160 that are generated, the EHD system 100 can increase the amount of energy extracted from the fluid stream 110. This is enabled by using a high channel density (e.g., a high density of manifold 210 orifices) within the charged particle generator 200, wherein each channel 220 generates an independent carrier fluid jet 150 to be dropletized. In some variants, this channel density can be higher than that achievable by using nozzles as the fluid channels 220.

Third, by generating a substantially uniform distribution of droplet sizes (e.g., wherein the generated droplets are all substantially the same size and/or mass), the EHD system 100 can confer higher energy extraction efficiencies over conventional systems. This can enable greater control over the amount of charge deposited on each droplet, which minimizes erratic charge loss due to Coulombic explosion and decreases the adverse effects of space charge. This can additionally enable greater control over the charged droplet 160's wind drag characteristics, such that the droplet parameters can be optimized to minimize droplet shorting back to the EHD system 100 and/or upstream collector, which in turn, increases energy extraction efficiency.

Fourth, by leveraging a simple design, the EHD system 100 can reduce manufacturing costs relative to conventional systems. For example, one variation of the charged particle generator 200 can be formed from a simple manifold 210 (e.g., a tube) with a set of through-holes drilled through the manifold thickness 216 to define the channels 220. In another variation, the charged particle generator 200 can be formed from a simple manifold 210 with a linear channel 228 (cut along the manifold length) and a secondary layer extending over the linear channel 228. The secondary layer can include a set of through-holes coincident with the linear channel 228, wherein the through-holes define the channels 220. This secondary layer can be stamped, drilled, fabricated (e.g., using semiconductor fabrication techniques), or otherwise manufactured.

### 2. System

As shown in FIG. 2, the electro-hydrodynamic (EHD) system includes a charged particle generator 200 including: a manifold 210, a channel 220, and a field shaper 240. The EHD system 100 can additionally include: a sensor 300, a controller 400, an electrical load 500, a reservoir 600, an upstream collector, and/or a downstream collector.

### 2.1 Charged Particle Generator

The charged particle generator 200 (e.g., charged particle generator 200 of the EHD system 100) functions to generate an electric field (working field 120) and to generate and emit charged particles into the fluid stream no. The charged particle generator 200 can include: a manifold 210, a channel 220, a field shaper 240, and/or any other suitable component. The charged particle generator 200 is preferably arranged upstream from the downstream collector, but can alternatively be arranged in any other suitable location along the fluid stream no. Each EHD system 100 can include one or more charged particle generators 200. The charged particle generator 200 and/or components thereof are preferably substantially static (e.g., does not move relative to the mounting point), but can alternatively be active. In one example, the charged particle generator 200 and/or components thereof can actuate relative to the wind direction. In one specific example, the charged particle generator 200 can be moved such that the resultant carrier fluid jet 150 is oriented at a predetermined angle to the fluid stream 110 (e.g., parallel the fluid stream no).

The charged particles are preferably charged droplets 160, but can alternatively be any suitable charged particle. The droplets are preferably all charged to a single polarity (e.g., positive or negative), but can alternatively be charged to different polarities (e.g., positive and negative). In the latter instance, the charge magnitude on oppositely charged droplets 160 can be substantially the same or different (e.g., wherein the positive droplets have a larger charge magnitude than the negative droplets). Alternatively, the charged particle generator can alternate between emitting positive and negative droplets over time. Alternatively, different charged particle generators (e.g., cells) of the EHD system can generate droplets of different polarities (e.g., a first charged particle generator generates positive droplets, a second charged particle generator generates negative droplets, etc.), wherein there can be more, equal, or less numbers of charged particle generators that generate droplets of the first polarity. The charge on each droplet can be: less than 50% of the Rayleigh limit for the droplet size, less than 25% of the Rayleigh limit for the droplet size, between 5% to 10% of the Rayleigh limit for the droplet size, between 4% to 7% of the Rayleigh limit for the droplet size less than 5% of the Rayleigh limit for the droplet size, 6% of the Rayleigh limit for the droplet size, 7% of the Rayleigh limit for the droplet size, more than 50% of the Rayleigh limit for the droplet size, or be any other suitable charge magnitude. The charged particle generator 200 preferably generates a substantially uniform population of droplet sizes (e.g., wherein all droplets, or a majority thereof, are substantially the same size), but can alternatively generate a uniform distribution of droplet sizes, or generate a population of droplets with any other suitable property. The charged droplet 160 diameter can be larger than 500 micrometers (e.g., 1 millimeter, 700 micrometers, etc.), approximately 500 micrometers, 400 micrometers, 300 micrometers, less than 200 micrometers, less than 140 micrometers, larger than 80 micrometers, less than 80 micrometers, and/or be any other suitable size. The charged droplet 160 size can be substantially constant across all ambient environment parameter values (e.g., across all wind speeds), be dynamically varied as a function of the ambient environment parameter values (e.g., by the controller 400), or be otherwise controlled. The droplets can be formed at 10 kHz, 20 kHz, 30 kHz, between 5 kHz to 30 kHz, or at any other suitable frequency. The droplet formation frequency can be substantially constant across all ambient environment parameter values (e.g., across all wind speeds), be dynamically varied as a function of the ambient environment parameter values (e.g., by the controller 400), or be otherwise controlled.

In one variation of charged particle generator operation, due to a pressure gradient across each of the plurality of channels 220 between the pressurized carrier fluid 140 within the manifold's lumen and the ambient environment exterior to the manifold 210, the pressurized carrier fluid 140 is forced through each of the plurality of channels 220. The pressurized carrier fluid 140 extends through each of the plurality of channels 220 as a continuous liquid as a carrier fluid jet 150, then dropletizes due to fluid instability (e.g., the Plateau-Rayleigh effect). Simultaneously, the carrier fluid jet 150 is immersed in a charging electric field (e.g., applied by the field shaper 240), which polarizes the pressurized liquid. Upon dropletization, the individual charged droplets 160 acquire a net charge, with a diameter of order the diameter of a single channel 220 in the manifold 210. However, the charged particle generator 200 can operate in any other suitable manner.

### 2.1.1 Manifold

The manifold 210 of the charged particle generator 200 functions to receive the pressurized carrier fluid 140 within the manifold interior, and to supply the pressurized carrier fluid 140 to the channels 220. The manifold 210 (e.g., nozzle rail) can additionally function to define and/or support the channels 220 that form the carrier fluid jets 150. The manifold 210 can additionally function as the upstream collector.

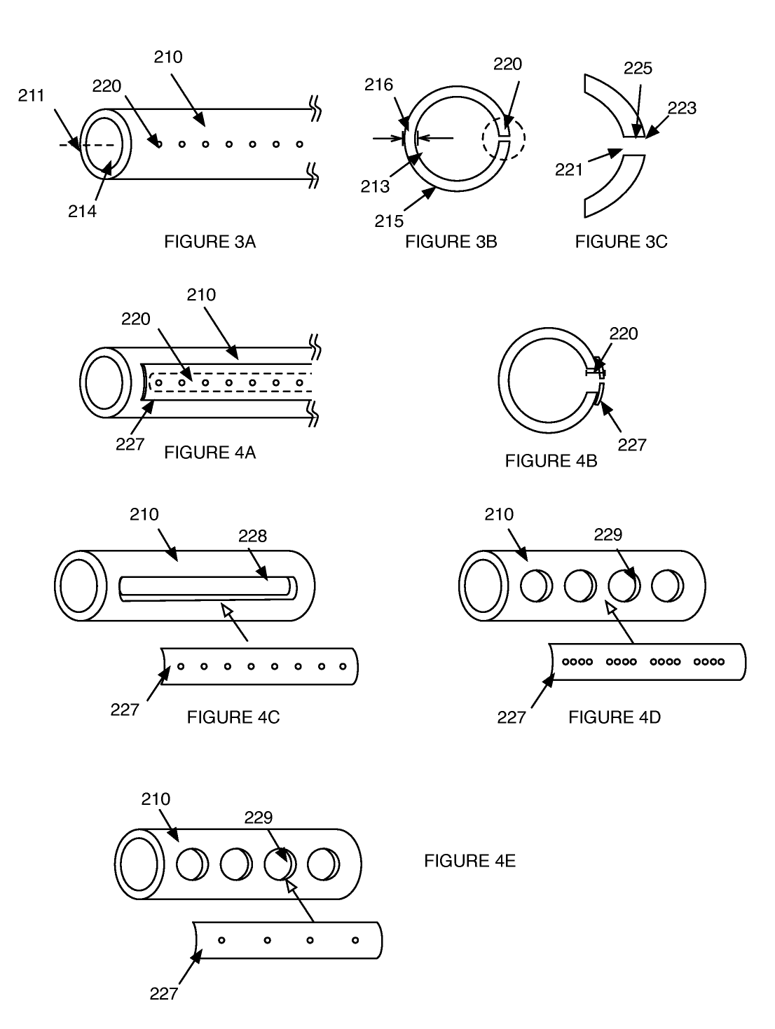

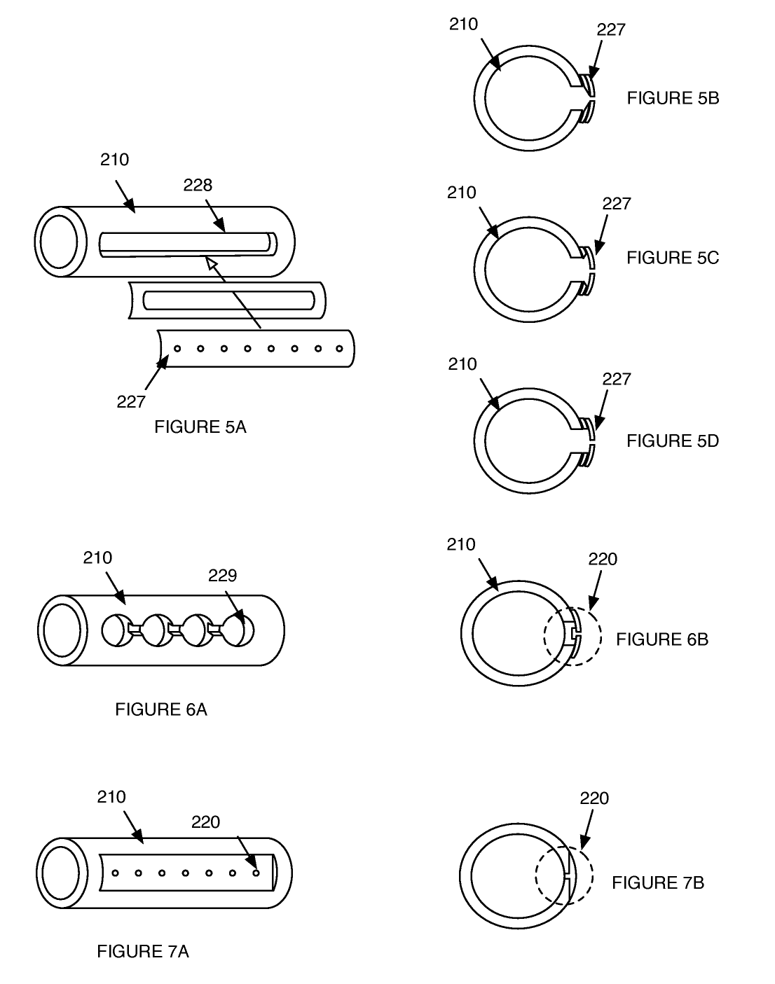

As shown in FIGS. 3A and 3B, the manifold 210 preferably defines a manifold interior (e.g., manifold lumen 214), a manifold exterior, a manifold thickness 216 separating the manifold interior from the manifold exterior, a manifold longitudinal axis 211, a downstream face (e.g., configured to be arranged downstream from the fluid stream 110), an upstream face (e.g., configured to be arranged downstream from the fluid stream 110), an apex (e.g., a highest manifold surface along a gravity vector), a nadir (e.g., a lowest manifold surface along a gravity vector), a first end, a second end opposing the first end, and/or any other suitable set of dimensions, surfaces, principal axes, or component. The manifold 210 can be configured to maintain an internal carrier fluid 140 pressure of less than 15 psi above atmospheric pressure, between 5 psi-10 psi above atmospheric pressure, more than 10 psi above atmospheric pressure, more than 15 psi above atmospheric pressure (e.g., 30 psi, 40 psi, 100 psi, etc. above atmospheric pressure), less than 5 psi above atmospheric pressure, or maintain any suitable internal pressure.

The manifold 210 is preferably a hollow tube, but can alternatively be a hollow airfoil or have any other suitable configuration (examples shown in FIGS. 10A to 10C). The manifold 210 is preferably substantially straight along the manifold length, but can alternatively be curved (e.g., toward the downstream face, toward the upstream face, along a plane perpendicular the downstream face, up, down, etc.), boustrophedonic, or have any other suitable configuration. The manifold cross section can be circular, ovular, regular polygonal (e.g., rectangular, triangular, etc.), or have any other suitable cross section. The manifold interior cross section can mirror the manifold exterior cross section, or be substantially different. In one variation, the manifold exterior forms an airfoil, the airfoil's trailing edge forms the downstream face and the leading edge forms the upstream face. However, the manifold 210 can be otherwise configured. The manifold interior cross section and/or manifold exterior cross section can be substantially constant along the manifold length or vary along the manifold length.

The manifold interior cross section can be on the order of micrometers (e.g., 80 micrometers to 140 micrometers, 500 micrometers or less, etc.), millimeters (e.g., 5 millimeters, 10 millimeters, etc.), centimeters, or be any other suitable size. The diameter of the manifold exterior cross section can be on the order of micrometers (e.g., 380 micrometers-440 micrometers, 800 micrometers or less, etc.), millimeters (e.g., 5 millimeters, 10 millimeters, etc.), centimeters, or be any other suitable size. The manifold interior cross section is preferably smaller than the manifold thickness 216, but can alternatively be larger or substantially the same size as the manifold thickness 216. The manifold length is preferably on the order of meters (e.g., 1 meter, 5 meters, 10 meters, etc.), but can alternatively be on the order of centimeters (e.g., 5 centimeters, 10 centimeters, etc.), millimeters, kilometers, or be any other suitable size. The manifold 210 can be electrically conductive or insulative. The manifold 210 can be made of plastic, metal (e.g., aluminum, stainless steel, titanium, an alloy, etc.), ceramic, or any other suitable material. The entire manifold 210 is preferably made of one material, but different portions of the manifold 210 can be made from different materials. In one example, the manifold 210 can be made of 200-300 um thick aluminum.

The manifold surface can be bare or include one or more surface treatments to minimize corrosion, minimize clogging, direct fluid flow, or promote any other suitable parameter. Examples of surface treatments include: anti-corrosion coatings, hydrophilic coatings, hydrophobic coatings, or any other suitable coating; anodizing; plating; etching; or any other suitable surface treatment. The surface treatment can be uniformly applied to all portions of the manifold 210, or different manifold 210 sections can have different treatments. For example, the manifold interior can have a different surface treatment from the manifold exterior, or a first section of the manifold length can have a different surface treatment from a second section of the manifold length.

The manifold interior can be substantially smooth and unobstructed, or include a set of internal features that function to influence fluid flow therethrough. The internal features preferably extend from the manifold interior surface 213, but can alternatively be formed by inserts inserted within the manifold lumen 214 (e.g., inserted along the manifold longitudinal axis 211), or be otherwise formed. The internal features can extend linearly (e.g., along the longitudinal axis), radially inward, radially outward (e.g., from the insert), spiral about the central manifold axis, extend arcuately, or have any other suitable configuration. Examples of internal features include: ridges, grooves, dimples, channels 220, or any other suitable internal feature. In one specific example, the manifold interior can include a set of channels 220 that guide or promote carrier fluid 140 flow toward the channels 220. The manifold 210 can include one or more internal features or sets thereof. The distribution of internal features along the manifold length or arcuate surface is preferably substantially uniform, but can alternatively be uneven.

The manifold 210 can additionally include external features. The external features can be aerodynamic features, which can function to: reduce manifold 210 drag in the fluid stream 110 (e.g., streamline the manifold 210), protect the carrier fluid jet 150, promote carrier fluid jet 150 formation, promote charged droplet 160 entrainment in the fluid stream 110, promote controlled vortex shedding, or perform any other suitable aerodynamic functionality. The external features can additionally or alternatively be electrostatic features, and function to shape the local space charge proximal the channel openings. However, the external features can perform any other suitable functionality. The external features can extend from the downstream face (e.g., form trailing edge features 219), the upstream face (e.g., form leading edge features 217), or from any other suitable manifold surface. The external features can extend parallel to the longitudinal axis, extend arcuately, extend radially outward, extend tangentially to the manifold exterior surface 215, spiral about the longitudinal axis, or have any suitable configuration. The external features are preferably symmetrically arranged about the channels 220 or a radial plane intersecting the channel centers and manifold central axis, but can alternatively asymmetrically arranged or otherwise arranged. The manifold 210 can include one or more external features or sets thereof. When the manifold 210 includes multiple external features, the external features are preferably substantially identical, but can alternatively be different (e.g., extend different distances from the manifold 210, have different shapes, etc.). Examples of external features include: ridges, grooves, dimples, channels 220, bumps, peaks, or any other suitable external feature. The exterior features can be formed: by the manifold itself (e.g., wherein the manifold 210 and exterior features are formed as a unitary piece), by an auxiliary piece to the manifold 210 (e.g., mounted to the manifold exterior), or by any other suitable component.

In a first example, the external features can include a first and second trailing edge feature 219 extending from a first and second manifold surface proximal the apex and nadir toward the downstream face, respectively. In a first specific example, the first and second trailing edge features 219 terminate before the most downstream point of the manifold 210 (example shown in FIG. 9A). In a second specific example, the first and second trailing edge features 219 extend beyond the furthest downstream point of the manifold 210 (examples shown in FIGS. 9B and 9C).

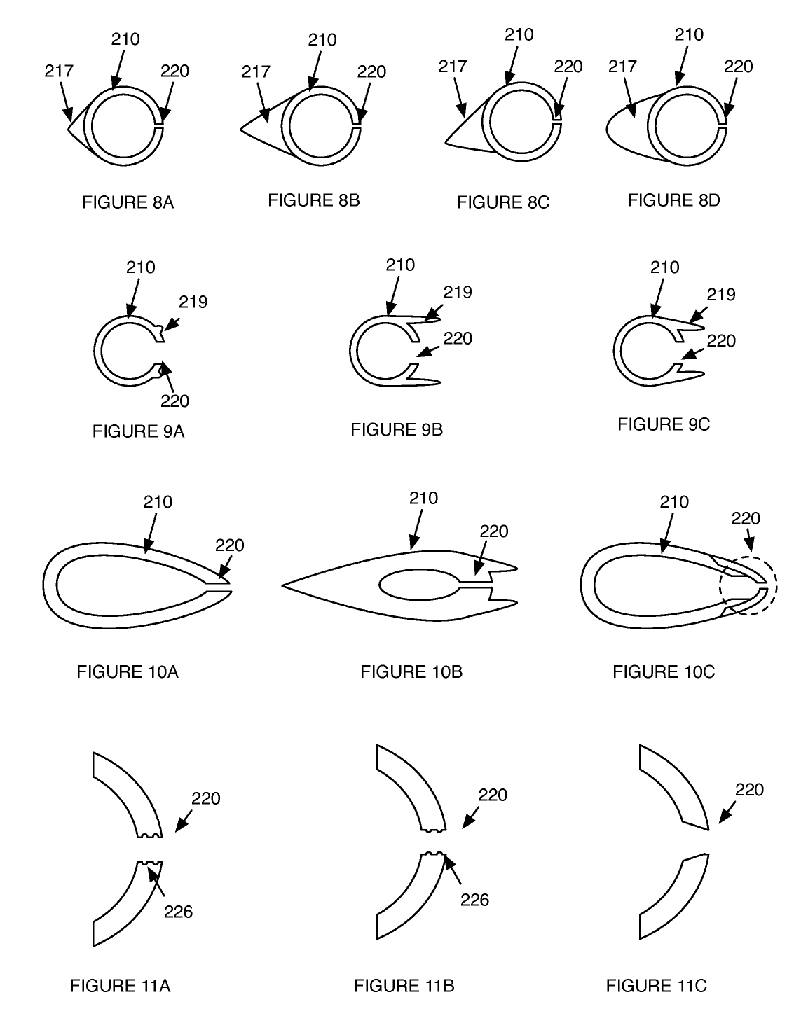

In a second example, the external features can include a leading edge feature 217. The leading edge feature 217 can be a linear peak defining an apex, wherein the linear peak can extend substantially parallel the manifold longitudinal axis 211. The linear peak is preferably substantially symmetric about the apex, but can alternatively be asymmetric (e.g., wherein a first side is shorter than or has a different curvature than the second side). The linear peak can be arranged with the apex substantially aligned with a radial plane intersecting the channel centers and manifold central axis (example shown in FIGS. 8A, 8B, and 8D), but can alternatively be offset from the radial plane (example shown in FIG. 8C) or otherwise arranged. The apex can be pointed and have a small radius (e.g., be 40% or less of the manifold 210 external radius or thickness, etc.), be convex and have a large radius (e.g., be 50% or more of the manifold 210 external radius or thickness, etc.; example shown in Example 8D), be concave, or have any other suitable configuration.

Each charged particle generator 200 can include one or more manifolds 210. When the charged particle generator 200 includes more than one manifold 210, the manifolds 210 can be individually connected to the reservoir 600, connected in series to the reservoir 600, connected in parallel to the reservoir 600, or otherwise connected to the reservoir 600. The manifolds 210 can be connected through a valve, an open secondary manifold 210, or otherwise connected together. The multiple manifolds 210 are preferably substantially evenly distributed (e.g., wherein the manifolds 210 are substantially equidistant from each other), but can alternatively be unevenly distributed. The multiple manifolds 210 are preferably all arranged between the field shapers 240 of the charged particle generator 200, more preferably substantially evenly distributed between the field shapers 240 but alternatively unevenly distributed, but can be otherwise arranged relative to the field shapers 240. The multiple manifolds 210 are preferably arranged with the respective longitudinal axes in parallel, but can alternatively be arranged at any suitable angle relative to each other. The multiple manifolds 210 are preferably substantially identical to each other, but can alternatively be different.

### 2.1.2 Channels

The channels 220 of the charged particle generator 200 function to generate carrier fluid jets 150 that dropletize into discrete carrier fluid droplets. The channels 220 preferably cooperatively generate the carrier fluid jets 150 with the carrier fluid pressure within the manifold 210, but can alternatively otherwise generate the carrier fluid jets 150. The carrier fluid jets 150 can be Rayleigh jets (e.g., wherein the jets dropletize due to fluid instabilities), Taylor cones, or be any other suitable fluid jet.

As shown in FIG. 3C, the channel 220 (carrier fluid channels, orifices, holes) preferably defines a first channel end 221, second channel end 223, and channel barrel 225 (channel bore) extending between the first channel end 221 and second channel end 223.

The first channel end 221 functions as the channel inlet, and is preferably fluidly connected to the manifold lumen 214, but can alternatively or additionally be connected to another channel 220 of the charged particle generator 200 or to any other suitable fluid source. The first channel end 221 preferably defines an inlet plane (e.g., plane extending along the edges of the first channel end 221). The inlet plane can be arranged with a normal vector (e.g., the inlet normal vector) oriented: perpendicular the manifold interior surface 213 (e.g., parallel a normal vector to the manifold interior surface 213), perpendicular a tangent to the manifold interior surface 213, parallel to the manifold interior surface 213, at an angle between perpendicular and parallel to the manifold interior surface 213 (e.g., 30° to the manifold interior surface 213, 60° to the manifold interior surface 213, etc.), at an angle between perpendicular and parallel to the tangent to the manifold interior surface 213, or be oriented at any other suitable angle. The first channel end 221 can be substantially flush with the manifold interior surface 213 (e.g., wherein the interface therebetween can be an edge, curved, ogived, or otherwise configured), or can additionally include end features. The end features can include: a protrusion extending along the edge of the first channel end 221, a depression extending along the edge of the first channel end 221 (e.g., a counterbore), radial fins extending from the edge of the first channel end 221, or any other suitable end feature.

The second channel end 223 functions as the channel outlet, and is preferably fluidly connected to the ambient environment, external the manifold 210, but can alternatively be fluidly connected to any other suitable endpoint. The second channel end 223 preferably defines an outlet plane (orifice plane, e.g., plane extending along the edges of the second channel end 223). The outlet plane can be arranged with a normal vector (e.g., the outlet normal vector) oriented: perpendicular the manifold exterior surface 215 (e.g., parallel a normal vector to the manifold exterior surface 215), perpendicular a tangent to the manifold exterior surface 215, parallel to the manifold exterior surface 215, at an angle between perpendicular and parallel to the manifold exterior surface 215 (e.g., 30° to the manifold interior surface 213, 60° to the manifold exterior surface 215, etc.), at an angle between perpendicular and parallel to the tangent to the manifold exterior surface 215, or be oriented at any other suitable angle. The second channel end 223 can be substantially flush with the manifold interior surface 213 (e.g., wherein the interface therebetween can be an edge, curved, ogived, or otherwise configured), or can additionally include end features. The end features can include: a protrusion extending along the edge of the first channel end 221, a depression extending along the edge of the first channel end 221 (e.g., a counterbore), radial fins extending from the edge of the first channel end 221, or any other suitable end feature.

The channel barrel 225 preferably fluidly connects the first channel end 221 to the second channel end 223, but can alternatively fluidly connect any other suitable set of inlets and outlets. The channel length (e.g., length of the channel barrel 225, distance between the first channel end 221 and second channel end 223, etc.) is preferably substantially coextensive with the manifold thickness 216 (e.g., equal to and aligned with the manifold thickness 216), but can alternatively be slightly longer or shorter (e.g., 0-10% longer or shorter, respectively) or substantially longer or shorter (e.g., more than 10% longer or shorter, respectively) than the manifold thickness 216. The channel 220 can be substantially straight, curved, or have any other suitable configuration. The channel cross section (e.g., cross section perpendicular the channel 220 longitudinal axis) can be circular, ellipsoid, polygonal (e.g., rectangular, triangular, etc.), or have any other suitable profile. The channel diameter can be smaller than 500 micrometers, larger than 500 micrometers, be 300 micrometers or smaller, be 100 micrometers or larger, be substantially the same size as the droplet to be formed, be a multiple of the droplet size (e.g., twice as large as the droplet to be formed), or be any other suitable size. The channel cross section is preferably substantially constant along the channel length, but can alternatively vary along the channel length. For example, the channel barrel 225 can taper inward toward second channel end 223 (example shown in FIG. 11C), taper outward toward second channel end 223, form a constricted neck between the first channel end 221 and second channel end 223, or have any other suitable configuration. The channel material is preferably the same as the manifold material, but can alternatively be different.

The surface of the channel barrel 225 is preferably smooth and bare, but can alternatively include a set of internal features and/or surface treatments that function to minimize corrosion, minimize clogging, direct fluid flow, or promote any other suitable parameter. Examples of internal features include grooves, protrusions extending toward the channel central axis (example shown in FIG. 10), dimples (example shown in FIG. 11A), or any other suitable internal feature. The internal features can extend radially inward from the channel barrel surface, along the channel barrel length, spiral about the channel barrel longitudinal axis (e.g., form threading), or be arranged in any other suitable manner. The internal features can be substantially uniformly distributed about the channel length and/or arcuate surface, concentrated toward one end or one arcuate portion, or otherwise arranged. Examples of surface treatments include: anti-corrosion coatings, hydrophilic coatings, hydrophobic coatings, or any other suitable coating; anodizing; plating; etching; or any other suitable surface treatment. The surface treatment can be uniformly applied to all portions of the channel 220, or different channel linear or arcuate sections can have different treatments. The channel surface treatment can be the same as a manifold surface treatment (e.g., interior surface treatment, exterior surface treatment, etc.), but can alternatively be different.

The channels 220 are preferably entirely or partially defined by the manifold thickness 216, but can alternatively be defined by any other suitable portion of the manifold 210. Alternatively, all or a portion of the channel length can be retained by the manifold thickness 216, but can alternatively be defined by any other suitable portion of the manifold 210. The channels 220 preferably extend radially outward from the manifold central axis, but can alternatively or additionally extend at a non-zero angle to the manifold radius, extend along a manifold chord, extend along a mean camber of manifold 210, extend at an angle to the manifold longitudinal axis 211 (e.g., extend perpendicular the longitudinal axis), extend along a tangent to the manifold exterior, or extend at any other suitable angle. The first channel end 221 is preferably contiguous with the manifold interior surface 213, but can alternatively terminate radially inward or outward of the manifold interior surface 213. The second channel end 223 is preferably contiguous with the manifold exterior surface 215, but can alternatively terminate radially inward or outward of the manifold exterior surface 215.

The channel 220 can be formed entirely by the manifold 210, be cooperatively formed by the manifold 210 and an auxiliary component 227, or be otherwise constructed. The manifold 210 and auxiliary component 227 preferably each define different portions of the channel length, but can alternatively define overlapping sections of the channel length. The different portions of the channel length are preferably contiguous, but can alternatively be separated by a distance. The auxiliary component 227 can function to define the second channel end 223, channel barrel 225 proximal the second channel end 223, intermediary portion of the channel barrel length, first channel end 221, channel barrel 225 proximal the first channel end 221, and/or define any other suitable portion of the channel 220. The auxiliary component 227 can be a perforated sheet (e.g., layer), an insert, and/or other auxiliary component 227. The same manifold 210 and/or auxiliary component 227 can concurrently define a plurality of channels 220. Alternatively, each manifold 210 and/or auxiliary component 227 can define a single channel 220. However, the channels 220 can have any other suitable construction or configuration.

In a first variation, the channel 220 is defined by a simple aperture 229 extending through the manifold thickness 216 (e.g., defined through the manifold thickness 216, example shown in FIGS. 3A-3C). In this variation, the channel 220 is formed as a singular piece with the manifold 210 (e.g., unitary construction). The first channel end 221 is flush with the manifold interior, and the second channel end 223 is flush with the manifold exterior. In this variation, the channel 220 can be laser drilled, laser perforated, machined (e.g., via CNC), etched, stamped, injection molded, or otherwise formed through the manifold thickness 216.

The manifold thickness 216 surrounding the channel 220 can be full thickness (e.g., substantially the same thickness as the upstream portion of the manifold 210), thicker than the manifold remainder (e.g., thicker than the upstream portion of the manifold 210), thinner than the manifold remainder (e.g., locally thinned), or have any other suitable thickness. When the manifold 210 is locally thinned, the manifold 210 can be thinned from the manifold exterior, manifold interior, both the manifold exterior or manifold interior, or from any other suitable portion. The manifold thickness 216 can be uniformly thinned along the manifold arcuate surface, non-uniformly thinned along the manifold 210 arcuate surface (e.g., wherein the manifold thickness 216 along a first portion of an arcuate segment is different from a second portion of the arcuate segment), or otherwise thinned. In one example, the manifold thickness 216 can be non-uniformly thinned such that the manifold exterior contiguous with the second channel end 223 is perpendicular to (e.g., tangential to) the channel 220 longitudinal axis and/or manifold radius (example shown in FIGS. 7A-7B). However, the manifold 210 can be otherwise thinned.

In a second variation, the channel 220 is defined by selectively blocking (e.g., occluding) portions of a manifold aperture 229 with an auxiliary component 227, such that the manifold 210 defines a first portion of the channel length (e.g., proximal the first channel end 221), and the auxiliary component 227 defines a second portion of the channel length (e.g., proximal the second channel end 223). In this variation, the manifold 210 includes an aperture 229 (e.g., a through-hole) with a diameter larger than the desired channel diameter, and the auxiliary component 227 defines one or more through-holes having desired channel diameter. The manifold aperture 229 can be a large through-hole defined through the manifold thickness 216, wherein the aperture 229 diameter is larger than the desired channel diameter (e.g., 10 times larger than the desired channel diameter, 50 times larger than the desired channel diameter, etc.). However, the manifold aperture 229 can be any other suitable size. In a first example (shown in FIG. 4C), the manifold aperture 229 can be a linear channel 228, extending substantially parallel the manifold longitudinal axis 211. In a second example (shown in FIG. 4D), the manifold aperture 229 can have a substantially circular cross section perpendicular the channel length. In a third example, the manifold 210 can include a plurality of manifold apertures 229 arranged in an array, wherein adjacent manifold aperture 229s are fluidly connected by a linear channel 228, defined through the manifold thickness 216 (example shown in FIG. 6A). This linear channel 228 can function to ensure unobstructed carrier fluid supply to manifold aperture 229s that might otherwise be blocked by webbing between adjacent manifold aperture 229s. However, the manifold aperture 229 can have any other suitable configuration.

The auxiliary component 227 is preferably arranged with one or more through-holes substantially aligned with the manifold aperture 229, but can be otherwise arranged. The auxiliary component 227 is preferably coupled to the manifold 210 (e.g., adhered, welded, screwed, clipped, press-fit, or otherwise coupled), but can alternatively be offset from the manifold 210 or otherwise retained relative to the manifold 210. When the auxiliary component 227 is adhered to the manifold 210, the adhesive can be applied along all or a portion of the auxiliary component edges, be applied between the auxiliary component 227 and manifold exterior (e.g., form an intermediary layer extending along all or a portion of the auxiliary component 227-manifold exterior interface, wherein the intermediary layer includes a channel 220 having substantially the same dimensions as the manifold aperture 229), or be otherwise arranged. The auxiliary component 227 can be removably coupled, permanently coupled, or otherwise coupled to the manifold 210. The auxiliary component 227 can be made of the same material as the manifold 210, a different material from the manifold 210, include the same surface treatment as the manifold 210, include different surface treatments from the manifold 210, or be otherwise related to the manifold 210.

In a first example, the auxiliary component 227 can be a perforated sheet (e.g., wherein the perforations are substantially the channel diameter). The perforated sheet is preferably larger than the manifold aperture 229, but can alternatively be smaller than the manifold aperture 229. The perforated sheet is preferably arranged over the manifold aperture 229 (e.g., coupled along the manifold exterior or interior), such that one or more of the perforations are substantially aligned with the manifold aperture 229 (examples shown in FIGS. 4E and 4D, respectively). However, the perforated sheet can be otherwise arranged.

In a second example, the auxiliary component 227 can be an insert (e.g., wherein the insert defines a portion of the channel length) that is inserted into the manifold aperture 229. The insert can have an exterior dimension substantially equal to or less than the manifold aperture inner dimension. The insert can have an interior dimension substantially equal to or otherwise related to the channel diameter. An insert can define a single channel 220 (e.g., be a nozzle), multiple channels 220, or any suitable number of channels 220. In one variation, the insert and/or nozzle can be one of those disclosed in U.S. application Ser. No. 13/264,306 filed 13 Oct. 2011, which is incorporated herein in its entirety by this reference. However, any other suitable insert or nozzle can be used. The channel features 226 or surface treatments can be defined along the insert interior or otherwise defined.

The channel 220 can be static or active (e.g., have lengths, diameters, or other dimensions that are dynamically reconfigurable). The channel 220 or charged particle generator 200 is preferably substantially stationary, but can additionally include a vibration mechanism that functions to vibrate the channel 220 or carrier fluid 140 therein at a predetermined frequency. This vibration can function to promote dropletization. The vibration mechanism is preferably physically connected to the channel 220 (e.g., first channel end 221, second channel end 223, channel barrel 225, etc.) or channel lumen, and is preferably electrically connected to the load, a battery of the EHD system 100, or any other suitable component. Examples of the vibration mechanism include: a piezoelectric mechanism, an ultrasound system, or any other suitable vibration mechanism.

Each manifold 210 preferably includes multiple channels 220, but can alternatively include a single channel 220. When the manifold 210 includes multiple channels 220, the channels 220 of the plurality are preferably substantially identical, but can alternatively be different. Adjacent channels 220 are preferably separated by a distance of at least half the channel diameter (e.g., wherein manifold material extends along the inter-channel 220 separation distance), but can alternatively be separated by a smaller distance (e.g., a quarter of the channel diameter) or larger distance (e.g., a 1.5 times the channel diameter, twice the channel diameter, etc.). The channels 220 are preferably arranged parallel each other (e.g., with adjacent channels 220 parallel), but can alternatively be arranged at a non-zero angle to each other. The channels 220 are preferably substantially evenly distributed along the manifold length (e.g., the channels 220 are equidistant from each other), but can alternatively be unevenly distributed.

The plurality of channels 220 is preferably arranged in an array on the manifold 210, but can alternatively be otherwise arranged. In one variation, the plurality of channels 220 are arranged in a row, wherein the row is oriented substantially parallel the manifold longitudinal axis 211. However, the row can be arranged at an angle to the manifold longitudinal axis 211, extend in a spiral about the manifold longitudinal axis 211, or be otherwise arranged. The manifold 210 can include one or more channel arrays. Multiple channel arrays are preferably arranged in parallel with each other, but can alternatively be arranged at an angle to each other. The channel array(s) are preferably arranged along the downstream face of the manifold 210, more preferably the portion of the manifold 210 furthest downstream (e.g., along the trailing edge of the manifold 210) but alternatively any other suitable portion of the downstream face. Alternatively, the channel arrays can be arranged along the upstream face or along any other suitable portion of the manifold 210.

In one specific example, the channels 220 are formed by apertures extending through the manifold thickness 216. The apertures (i.e., channels 220) have round cross sections that remain substantially constant along the aperture length. The aperture diameter is between 80-140 micrometers. The aperture length is approximately 250 micrometers, and equivalent to the manifold thickness 216. Adjacent apertures are arranged approximately 300 micrometers center-to-center (e.g., 20 micrometers to 140 micrometers edge-to-edge). Each manifold 210 includes approximately 3000 channels 220 per linear meter of manifold 210. However, the channels 220 and manifold 210 can be configured in any other suitable manner.

In operation, the manifold 210 is preferably oriented with the channels 220 (e.g., second channel ends 223) arranged furthest downstream (e.g., such that the channels 220 are defined along the manifold downstream face and/or trailing edge, example shown in FIG. 2). In this variation, the charged particle generator 200 can inject droplets into the fluid stream 110 along a vector substantially parallel the fluid stream 110.

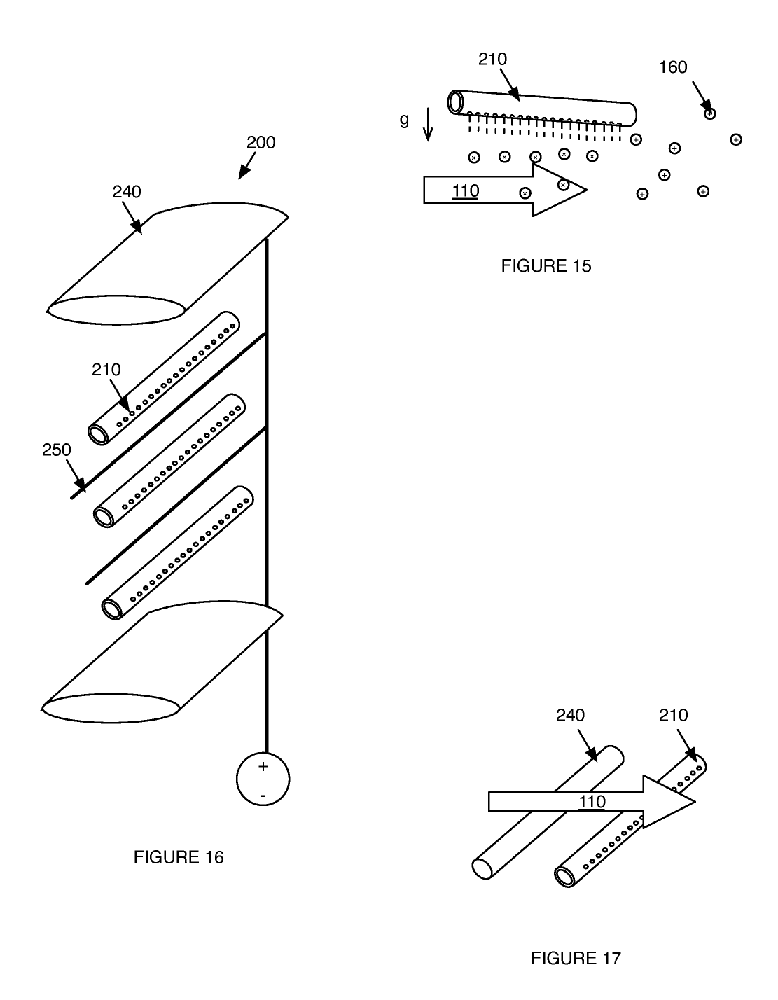

Alternatively, the manifold 210 can be oriented with the channels 220 arranged along the lowermost portion of the manifold 210 along a gravity vector (e.g., along the nadir, example shown in FIG. 15). The channels 220 can be arranged with the channel axes substantially parallel the gravity vector, with normal vectors to the outlet planes substantially perpendicular the gravity vector, or be otherwise arranged. In this variation, the charged particle generator 200 can inject droplets into the fluid stream 110 along a vector substantially perpendicular the fluid stream 110. Alternatively, the manifold 210 can be oriented with the channels 220 arranged in any other suitable angle relative to the fluid stream 110.

### 2.1.3 Guard Features

In some variants, the manifold 210 can additionally include guard features 230 that function to lower the electric field in the immediate vicinity of the jet emitted by the end channel 220a (end jet), which can function to prevent local corona. The guard features 230 are preferably arranged along the end of the array of the plurality of channels 220 (e.g., at the end of the row of channels 220), but can alternatively or additionally be arranged proximal an end of the manifold 210, arranged proximal the channel 220 at the end of the array (end channel 220a), arranged an arcuate distance away from the end channel 220a along a plane perpendicular to the manifold longitudinal axis 211 and intersecting the end channel 220a, arranged partway along the length of the row of channels, or be arranged in any other suitable location. The guard features 230 can be arranged: in line with the channel array (e.g., in-line with the row of channels), above the channel array (e.g., separated by an arcuate distance on the manifold from the row of channels), or arranged in any other suitable location on the manifold relative to the channel array. The manifold 210 preferably includes a set of guard features 230 for each end of the channel array, but can alternatively include a single set of guard features 230 for each array, a single set of guard features 230 for all arrays on the manifold 210, a single pair of guard feature 230 sets for all arrays on the manifold 210, a set of guard features 230 for a predetermined proportion of the array, or include any suitable number of guard features 230. In one example, the manifold 210 includes a first set of guard features 230 proximal the first end of the channel array and a second set of guard features 230 proximal the second end of the channel array.

The guard features 230 can include channels 220, protrusions, dimples, grooves, or any other suitable set of features. The guard features 230 can be made of electrically conductive material, electrically insulative material, or any other suitable material. Each set of guard features 230 preferably includes an odd number of guard features 230, but can alternatively include an even number of guard features 230. Each set of guard features 230 can include one, two, three, or any suitable number of guard features 230. When the set of guard features 230 includes multiple guard features 230, the guard features 230 are preferably substantially evenly distributed (e.g., along an alignment vector or pattern, about the end channel 220a, etc.), but can alternatively be unevenly distributed.

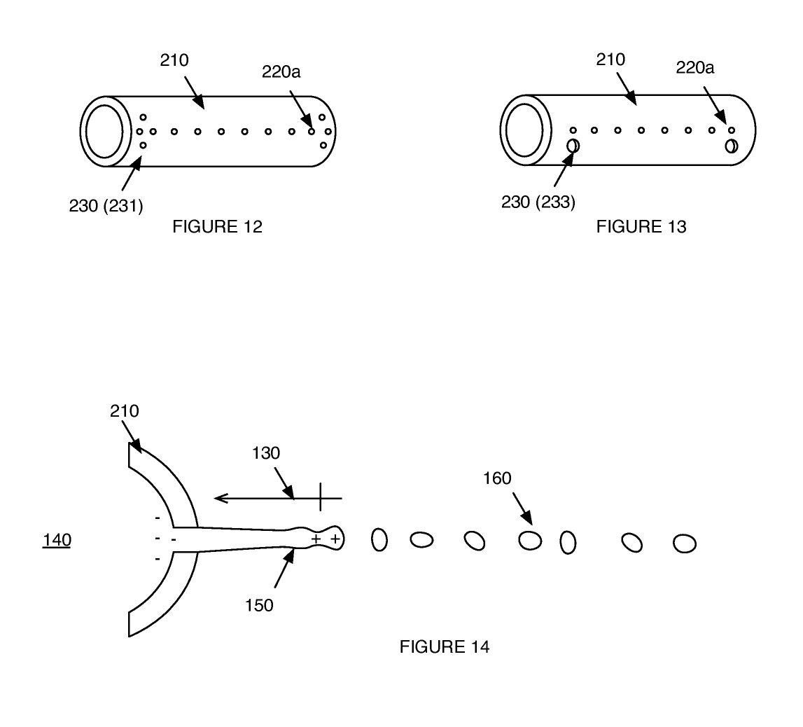

In a first variation, the guard features 230 include a plurality of channels 220 (guard channels 231) that generate conductive jets, wherein the conductive jets lower the local electric field proximal the end jet of the array (example shown in FIG. 12). The guard channels 220 are preferably substantially similar to the channels 220 in the array, but can alternatively be different. The guard channels 220 are preferably fluidly connected to the manifold lumen 214 at a first end (e.g., fluidly connected to the carrier fluid 140), and fluidly connected to the ambient environment at a second end, but can alternatively be connected to any other suitable set of endpoints.

In a first embodiment of the first variation, the guard channels 220 can be arranged in a line. The line of guard channels 220 can be oriented: perpendicular to the channel array axis (array axis), parallel to the array axis, at an angle to the array axis (e.g., 30° to the array axis, 45° to the array axis, 60° to the array axis, etc.), or at any other suitable angle. In a second embodiment of the first variation, the guard channels 220 can be arranged along a circular segment. The circular segment can be substantially centered about the array axis or offset from the array axis (e.g., biased above or below the array axis). The circular segment can be concave relative to the center of the channel array (array center), convex relative to the array center, or otherwise arranged. However, the set guard channels 220 can be arranged in any other suitable pattern and be arranged in any suitable orientation relative to the array of channels 220.

In a second variation, the guard feature 230 includes a projection 233 extending from the manifold exterior surface 215 proximal the end channel 220a, wherein the projection can disrupt the local electric field proximal the end channel 220a (example shown in FIG. 13). The projection can be: hemispherical, pyramidal, or have any other suitable configuration. The projection can be arranged: between the end channel 220a and the proximal manifold end, along an arcuate segment shared by the end channel 220a, along a radial vector extending from the end channel 220a, or be arranged in any other suitable location. However, the guard feature 230 can have any other suitable construction and be arranged in any other suitable location.

### 2.1.4 Field Shaper

The field shaper 240 of the charged particle generator 200 functions to generate a charging field 130 (polarizing field) proximal the channels 220, wherein the charging field 130 charges the carrier fluid 140 to a single polarity (example shown in FIG. 2). The field shaper 240 can additionally function to shape the space charge downstream from the channels 220, generate the working field 120, or perform any other suitable functionality. The field shaper 240 preferably biases the tip of the carrier fluid jet 150 at a single polarity, but can alternatively charge the carrier fluid droplets to a single polarity or otherwise cooperatively generate charged droplets 160 with the manifold 210. Alternatively, the field shaper 240 can generate a charging corona, charging plasma, or any other suitable charging feature. The field shaper 240 preferably generates a substantially uniform and/or homogenous electric field (charging field 130) proximal the second channel end(s) 223, but can alternatively generate a non-uniform electric field proximal the second channel end(s) 223. The substantially uniform charging field 130 can be applied: at the second channel end 223; at a predetermined distance away from the second channel end 223, distal the manifold exterior surface 215, etc.); or at any other suitable location. The predetermined distance is preferably approximately the anticipated jet length (e.g., such that the uniform charging field 130 is applied at the carrier fluid jet 150 tip), but can alternatively be any other suitable distance from the second channel end 223.

The field shaper ends can additionally include end features that function to prevent corona formation in the region. The end features preferably influence the combined field (e.g., combined system and space charge), such that the combined field on the field shaper that does not exceed a threshold electric field parameter. The threshold electric field parameter can be between 2-5 kV/mm, below 5 kV/mm, above 5 kV/mm, 3 kV/mm, or be any other suitable field strength. The threshold electric field parameter can remain substantially constant, or dynamically vary based on environmental and operating conditions (humidity, shorted droplets, etc.). For example, the threshold electric field parameter can be lowered to 2.1 kV/mm or less based on the environmental and/or operating conditions (e.g., when the proportion of shorted droplets increases). The end features preferably include a combination of convex and flat exterior surfaces, with rounded or smooth interfaces (e.g., tangency or interior edges/corners between the constituent surfaces), but can alternatively be otherwise configured. Examples of end feature geometries include: rounded ends, tapered ends, ends with semi-disc geometries with a maximum diameter equal to or greater than the chord length of the field shaper, truncated disks with a minor diameter equal to or greater than that of the field shaper, or any other suitable geometry. For the truncated disk variant, the radius of the section does not have to be uniform. For example, the radius of the section can be larger or smaller at the leading or trailing edge of the shaper termination. In one specific example, the end features include convex sections of toroids with a major diameter equal to or greater than the chord length of the field shaper and a minor diameter equal to or greater than the thickness of the field shaper. In a second specific example, the end features can have an exposed surface defined by sweeping a 2-D cross section including one or more rounded sections along a sweep path. The 2-D cross section can be an ellipsoid, circular arc, polyline, curve of non-uniform radius, or have any other suitable shape. The sweep path can be an ellipsoid, circular arc, polyline, curve of non-uniform radius, or have any other suitable shape. However, the end feature can have any other suitable geometry.

In operation, the field shaper 240 is preferably biased at the first polarity (e.g., the desired polarity of the charged droplets 160), but can alternatively be biased at the second polarity (e.g., the polarity opposing the first polarity) or at any other suitable polarity. The field shaper 240 is preferably held at the same polarity throughout EHD system 100 operation, but can alternatively be cycled between the first and second polarities at a predetermined frequency, in response to the occurrence of a cycling event (e.g., in response to increased droplet shorting), or at any other suitable time. The field shaper 240 potential is preferably dynamically adjusted based on ambient environment parameters (e.g., increased in response to increased wind speed), but can alternatively be dynamically adjusted based on the desired droplet charge, adjusted based on any other suitable parameter, or maintained as a substantially constant potential. The field shaper 240 can remain substantially static relative to the manifold 210 and/or EHD system 100 mounting point, or can actuate relative to the manifold 210 and/or EHD system 100 mounting point (e.g., actuate based on the fluid vector direction). The field shaper 240 position can be dynamically adjusted: angularly (e.g., rotate about the longitudinal axis), vertically (e.g., wherein the distance between the manifold 210 and field shaper 240 can be changed), laterally (e.g., wherein the field shaper 240 can be shifted along a vector perpendicular the longitudinal axis), or otherwise adjusted. The field shaper 240 is preferably electrically connected to a power source and the controller 400 (e.g., wherein the controller 400 controls field shaper 240 operation), but can alternatively or additionally be connected to any other suitable component.

The field shaper 240 is preferably a separate and distinct component from the manifold 210. However, the manifold 210 or a portion thereof can form the field shaper 240. The field shaper 240 can be a rail electrode, point electrode, toroidal electrode, or any other suitable type of electrode. The field shaper 240 preferably has an ellipsoid cross section, but can alternatively be shaped as an airfoil or have any other suitable configuration. The field shaper 240 is preferably wider than the manifold 210, but can alternatively be thinner than the manifold 210 or the same width as the manifold 210. The field shaper 240 is preferably taller than the manifold 210, but can alternatively be shorter than the manifold 210 or the same height as the manifold 210. The field shaper 240 is preferably substantially the same length as the manifold 210, but can alternatively be longer or shorter than the manifold 210. The field shaper 240 is preferably made of electrically conductive material, but can alternatively be made of any other suitable material. The field shaper 240, like the manifold 210, can include a surface treatment (e.g., any of the ones described above), but can alternatively have a surface that remains substantially bare and untreated. In one variation, the field shaper 240 can be that disclosed in U.S. application Ser. No. 14/920,009 filed 22 Oct. 2015, which is incorporated herein in its entirety by this reference. However, any other suitable field shaper 240 can be used.

The field shaper 240 can include one or more electrodes (e.g., two electrodes, three electrodes, etc.). The electrodes of the field shaper 240 can be arranged in a singular housing, or be arranged in separate and distinct housings. In the latter variation, the electrodes are preferably substantially evenly distributed about the manifold 210 (e.g., wherein each electrode is equidistant to the manifold 210; wherein the manifold 210 is centered between the field shaper 240 electrodes; etc.), but can alternatively be unevenly distributed about the manifold 210 or otherwise arranged. The electrodes of the field shaper 240 are preferably all held at the same polarity and potential (e.g., held at the same voltage), but can alternatively be held at different polarities, different potentials, or be maintained at any other suitable electrical parameter value.

The field shaper 240 can be arranged with the field shaper 240 longitudinal axis and/or major field shaper 240 plane arranged parallel, perpendicular, or at any other suitable angle to the manifold longitudinal axis 211. The field shaper 240 can be arranged with the major field shaper 240 plane parallel, perpendicular, or at any other suitable angle to a gravity vector. The field shaper 240 can be arranged with the major field shaper plane parallel, perpendicular, or at any other suitable angle to the fluid vector. The field shaper 240 can be arranged, relative to the manifold 210: upstream (example shown in FIG. 17), downstream, vertically above (e.g., along a gravity vector), vertically below (e.g., along a gravity vector), at the same position along the fluid stream 110 as the manifold 210, at the same height as the manifold 210, or at any other suitable location relative to the manifold 210. For example, the field shaper 240 can be retained a longer distance away from a mounting surface, retained a shorter distance away from the mounting surface, or retained substantially the same distance away from the mounting surface, respectively. The field shaper 240 can be arranged, relative to the channels 220 (e.g., the channel array): proximal a manifold face opposing the manifold face defining the channels 220 (e.g., proximal the upstream face), proximal a manifold face a predetermined arcuate distance from the manifold face defining the channels 220 (e.g., proximal the manifold 210 nadir or apex), proximal the manifold face defining the channels 220, or at any other suitable location relative to the manifold 210. The manifold 210 is preferably centered along the field shaper width, but can alternatively or additionally be centered along the field shaper length, centered along the field shaper height, offset relative to the field shaper width, length, or height, or otherwise arranged relative to the field shaper 240.

Each charged particle generator 200 can include one or more field shapers 240. When the charged particle generator 200 includes multiple field shapers 240, the field shapers 240 can be arranged with the major planes and/or longitudinal axes perpendicular each other, parallel each other, or at any suitable angle to each other. The field shapers 240 of the plurality are preferably all held at the same polarity and potential (e.g., held at the same voltage), but can alternatively be held at different polarities, different potentials, or be maintained at any other suitable electrical parameter value. The multiple field shapers 240 can be connected in series, connected in parallel, or otherwise connected together. The field shapers 240 are preferably substantially evenly distributed about the manifold 210 (e.g., wherein each field shaper 240 is equidistant to the manifold 210; wherein the manifold 210 is centered between the field shapers 240; etc.), but can alternatively be unevenly distributed about the manifold 210 or otherwise arranged. In a first specific example, the manifold 210 is centered (e.g., vertically and laterally) between a first and second field shaper 240, wherein the manifold 210, first field shaper 240, and second field shaper 240 are arranged in parallel. In a second specific example, the manifold 210 is vertically centered but laterally offset from the first and second field shapers 240. In a third specific example, the charged particle generator 200 includes multiple manifolds 210, wherein the manifolds 210 are laterally centered relative to the first and second field shapers 240 and substantially evenly distributed along the distance separating the first and second field shapers 240. However, the manifold 210 can be otherwise arranged relative to the field shapers 240.

### 2.1.5 Secondary Electrodes

The charged particle generator 200 can additionally include secondary electrodes 250, which function to homogenize charging field 130 proximal the second channel ends 223 (example shown in FIG. 16). This can be particularly desirable when multiple manifolds 210 are arranged between a field shaper pair.

The secondary electrodes 250 are preferably biased at the first polarity (e.g., the droplet polarity), but can alternatively be biased at the second polarity. When the charged particle generator 200 includes multiple secondary electrodes 250, all secondary electrodes 250 can be biased to the same polarity or different polarities. The multiple secondary electrodes 250 can be connected in series, connected in parallel, or otherwise connected together. The secondary electrodes 250 can be connected in series, connected in parallel, or otherwise connected to the field shaper 240. Alternatively, the secondary electrodes 250 can be substantially disconnected form the field shaper 240. The secondary electrodes 250 are preferably statically retained relative to manifold 210, but can alternatively be adjustable. Secondary electrode 250 adjustment can be controlled by the controller 400 or by any other suitable system. The secondary electrodes 250 are preferably electrically connected to and controlled by the controller 400, and can additionally or alternatively be connected to a power source (e.g., the battery), the field shaper 240, or to any other suitable component.

The secondary electrodes 250 can be rail electrodes, point electrodes, or any other suitable type of electrode. The secondary electrodes 250 can be arranged with a longitudinal axis or major plane: parallel, perpendicular, or at any other suitable angle relative to the field shaper 240 longitudinal axis or major plane and/or manifold longitudinal axis 211 or major plane. The secondary electrodes 250 can be substantially aligned with the manifold 210 relative to the field shaper 240 (e.g., wherein a common plane intersects the manifold longitudinal axis 211, the secondary electrode 250 longitudinal axis, and the field shaper 240), but can alternatively be offset or otherwise arranged.

The charged particle generator 200 can include one or more secondary electrodes 250. The charged particle generator 200 can include one secondary electrode 250 for each space between adjacent manifolds 210 (e.g., wherein the number of secondary electrodes 250 can be the number of manifolds 210, less one), one secondary electrode 250 for each manifold 210 pair, one secondary electrode 250 for a plurality of electrodes, or any suitable number of electrodes. The secondary electrodes 250 are preferably substantially evenly distributed along the distance between a field shaper pair, but can alternatively be unevenly distributed. The secondary electrodes 250 are preferably substantially equidistant from adjacent manifolds 210, but can alternatively be unevenly distributed. One or more secondary electrodes 250 can be arranged within the space between adjacent manifolds 210.

In a specific illustrative example, the charged particle generator 200 can include four manifolds 210 evenly distributed between a field shaper pair. The charged particle generator 200 can additionally include three secondary electrodes 250 aligned with the manifolds 210, wherein the first secondary electrode 250 is arranged between the first and second manifold 210, the second secondary electrode 250 is arranged between the second and third manifold 210, and the third electrode is arranged between the third and fourth manifold 210. Alternatively, the charged particle generator 200 can include a single secondary electrode 250 arranged between the second and third manifold 210. However, the charged particle generator 200 can include any other suitable electric field-homogenizing component.

In a specific example of the charged particle generator 200, the charged particle generator 200 includes: a manifold 210, an array of channels 220, and a field shaper pair. The manifold 210 can be a hollow tube or hollow airfoil. The array of channels 220 is preferably defined through the manifold thickness 216, wherein the second channel ends 223 preferably terminate along the exterior surface of the manifold trailing edge. Each channel 220 of the array is preferably substantially identical, and has a substantially constant, circular cross section with a diameter of less than 500 micrometers, more preferably between 400 micrometers and 200 micrometers (e.g., approximately 300 micrometers), but can alternatively be any other suitable size. The inter-channel 220 distance between adjacent channels 220 is preferably less than three times the channel diameter, but can be between 0.5 to 2 times the channel diameter (e.g., be 150 micrometers), or be any other suitable distance. The array axis is preferably arranged substantially parallel the manifold trailing edge. The charged particle generator 200 preferably includes a single row of channels 220, but can alternatively include multiple rows, wherein the multiple rows are substantially evenly distributed about the manifold trailing edge. The field shapers 240 of the field shaper pair are both rail electrodes with ellipsoid cross sections (e.g., perpendicular the respective field shaper 240 longitudinal axis), arranged with the major axes perpendicular a gravity vector. The field shaper pair is arranged with the first field shaper 240 above the manifold 210 and the second field shaper 240 below the manifold 210, wherein the manifold 210 is substantially centered (e.g., vertically and laterally) between the first and second field shapers 240. Both field shapers 240 are biased at the first polarity (e.g., positive polarity).

### 2.2 Support

The support 800 of the EHD system 100 functions to support and mount charged particle generator 200 to a support surface. The support 800 can additionally electrically isolate charged particle generator 200 and/or the remainder of EHD components from the carrier fluid source 170 and/or support surface. The support 800 can additionally function to retain the relative positions of the EHD components. The support 800 can be electrically conductive, electrically insulative, thermally conductive, thermally insulative, or have any other suitable material property. The support 800 can be made of metal, plastic, or any other suitable material. The support 800 can be a pole (e.g., a fixed-length pole, adjustable pole, etc.), a frame, a buoy, a tethered kite, an untethered kite, a balloon, or any other suitable support. The support 800 can be substantially static or be dynamically adjustable (e.g., controlled by the controller 400 or other control system). The support 800 can be hollow or solid. In a second variant, when the support 800 is hollow, the support 800 can further define a fluid connection between the carrier fluid source 170 and the reservoir 600.

The support 800 can mount (e.g., be physically connected to): the charged particle generator 200 (e.g., the manifold 210(s), the field shaper 240(s), the secondary electrode 250(s), etc.), the reservoir 600, the sensor 300, the controller 400, or any other suitable EHD component. The EHD system 100 can include one or more supports, wherein each support can mount one or more of the EHD components. In one variation, the support 800 can be that disclosed in U.S. application Ser. No. 13/948,501 filed 23 Jul. 2013, which is incorporated herein in its entirety by this reference. However, any other suitable support can be used.

### 2.3 Sensor

The sensor 300 of the EHD system 100 functions to monitor an ambient environment parameter of the ambient environment surrounding the EHD system 100. The sensor 300 can be configured to measure (e.g., record a measurement of, monitor) the ambient environment proximal the second channel end 223, but can alternatively monitor the ambient environment proximal the upstream manifold face, upstream from the EHD system 100, downstream from the EHD system 100, or monitor the ambient environment parameters of any other suitable location. The sensor 300 can measure the wind speed, wind acceleration, humidity, light, temperature, pressure, space charge, or any other suitable ambient environment parameter. The sensor 300 can be a fluid velocity sensor 300 (e.g., wind speed sensor 300), humidity sensor 300, light sensor 300, pressure sensor 300, temperature sensor 300, or any other suitable sensor 300.

The sensor 300 can be connected to the controller 400 and supply the ambient environment measurements to the controller 400 in real time, near-real time, or at any other suitable frequency. The sensor 300 can be electrically connected to the controller 400, physically connected to the controller 400 (e.g., wired to the controller 400), wirelessly connected to the controller 400, or otherwise connected to the controller 400. The sensor 300 can be mounted to the manifold 210, field shaper 240, secondary electrode 250, reservoir 600, retained a predetermined distance away from the manifold 210, field shaper 240, secondary electrode 250, or reservoir 600, or be retained in any other suitable location. The EHD system 100 can include one or more sensors 300, wherein the sensors 300 can be of the same type or different type.

### 2.4 Controller

The controller 400 of the EHD system 100 functions to adjust EHD system 100 operation based on the sensor 300 measurements (e.g., ambient environment parameter measurements). The controller 400 can additionally control charged particle generator 200 operation (e.g., adjust the amount of charge per droplet), field shaper 240 operation (e.g., control the polarity and/or potential that the field shaper 240 is held at), EHD system 100 component orientation, or operation of any other suitable component based on the sensor 300 measurements, amount of electrical energy extracted from the fluid stream 110, power storage system SOC, or based on any other suitable parameter.

The amount of charge on each droplet is preferably varied as a function of the wind speed (e.g., increased with increasing wind speed and decreased with decreasing wind speed), but can be alternatively controlled. The orientation of EHD system 100 components are preferably controlled to achieve a desired droplet injection angle relative to the fluid stream 110 or fluid vector (e.g., perpendicular, parallel, any other suitable angle), but can alternatively or alternatively be controlled to achieve a desired carrier fluid jet angle relative to the fluid stream 110 or fluid vector (e.g., perpendicular, parallel, any other suitable angle), desired charging field 130 orientation relative to the fluid stream 110 or fluid vector (e.g., perpendicular, parallel, any other suitable angle), or otherwise controlled.

The controller 400 can be electrically connected to the sensors 300, electrically connected to the field shaper 240, electrically connected to the power source and/or load, or electrically connected to any other suitable component. The controller 400 can be supported by the support 800, mounted to the reservoir 600, mounted to the charged particle generator 200, or mounted to any other suitable component. Examples of the controller 400 include: a CPU, GPU, microcontroller 400, or any other suitable computing system or processor. The controller 400 can be wired or wirelessly connected (e.g., via WiFi, a cellular network, satellite, etc.) to a remote computing system (e.g., server, mobile device, etc.) or any other suitable computing endpoint. The controller 400 can receive control instructions, report (e.g., send) operation data, or otherwise interact with the computing endpoint. However, the controller 400 can be otherwise configured or operated.

### 2.5 Electrical Load

The electrical load 500 of the EHD system 100 functions to extract energy from charged particle flow against the working electric field. The electrical load 500 is preferably electrically coupled in series between the upstream and downstream collectors (e.g., completes an electrical circuit between the upstream and downstream collectors), but can alternatively be electrically connected between the upstream collector and the ambient environment (e.g., the carrier fluid source 170, etc.), or be electrically connected between the upstream collector and any other suitable endpoint. In one example, the electrical load 500 can be electrically connected to (e.g., wired to) the charged particle generator 200, more preferably the manifold 210 (e.g., carrier fluid 140 within the manifold lumen 214, manifold exterior, etc.) but alternatively the field shaper 240 or any other suitable charged particle generator 200 component. In a second example, the electrical load 500 can be electrically connected to the reservoir 600. The electrical load 500 can be resistive, capacitive, or be any other suitable electrical load 500. The electrical load 500 can additionally include a power conditioning circuit or any other suitable circuitry.

The electrical load 500 can additionally include a power storage system 520 that functions to store the power extracted by the EHD system 100. The power storage system 520 can additionally function as a power supply that powers the powered components of the EHD system 100 (e.g., field shaper 240, sensors 300, controller 400, motors, etc.). Alternatively, the EHD system 100 can include a separate power supply. The power storage system 520 and/or power supply can be a secondary battery (e.g., a rechargeable battery), but can alternatively be a primary battery, fuel cell system, kinetic storage system, or be any other suitable storage system. The power storage system 520 and/or power supply can have a lithium chemistry, nickel-cadmium chemistry, or any other suitable chemistry. The power storage system 520 can be connected in parallel to the electrical load 500, connected in series to the electrical load 500, or be otherwise connected to the electrical load 500.

### 2.6 Reservoir

The reservoir 600 of the EHD system 100 functions to retain and supply carrier fluid 140 to the charged particle generator 200. The reservoir 600 is preferably fluidly connected to the manifold 210, more preferably the manifold lumen 214, of the charged particle generator 200, but can alternatively or additionally be fluidly connected to the channels 220 or any other suitable portion of the manifold lumen 214.

The reservoir 600 can be an open container, closed container, or be any other suitable container. The reservoir 600 is preferably configured to retain a pressurized fluid (e.g., maintain an internal pressure higher than the ambient pressure), but can alternatively be configured to maintain an internal pressure lower than or equal to the ambient pressure. The reservoir 600 can be rigid, flexible, or have any other suitable rigidity. The reservoir 600 can be electrically conductive, electrically insulative, or have any other suitable material property. The reservoir 600 can be made of metal (e.g., steel, aluminum, etc.), plastic, ceramic, or any other suitable material. The reservoir 600 is preferably mounted on the support 800, but can alternatively be otherwise retained. The EHD system 100 can include one or more reservoirs 600. The multiple reservoirs 600 can be fluidly connected in parallel, in series, or in any other suitable configuration to the manifold 210 and/or carrier fluid source 170.

The reservoir 600 can include a fluid inlet configured to receive carrier fluid 140 from the carrier fluid source 170 and/or a fluid outlet configured to supply carrier fluid 140 to the remainder of the EHD system 100. In one variation, the reservoir 600 includes both the fluid inlet and fluid outlet. In a second variation, the reservoir 600 includes a single fluid aperture 229 that functions as both the fluid inlet and fluid outlet. The fluid inlet is preferably fluidly connected to the manifold lumen 214 by a secondary manifold 210, but can be otherwise connected to the charged particle generator 200.

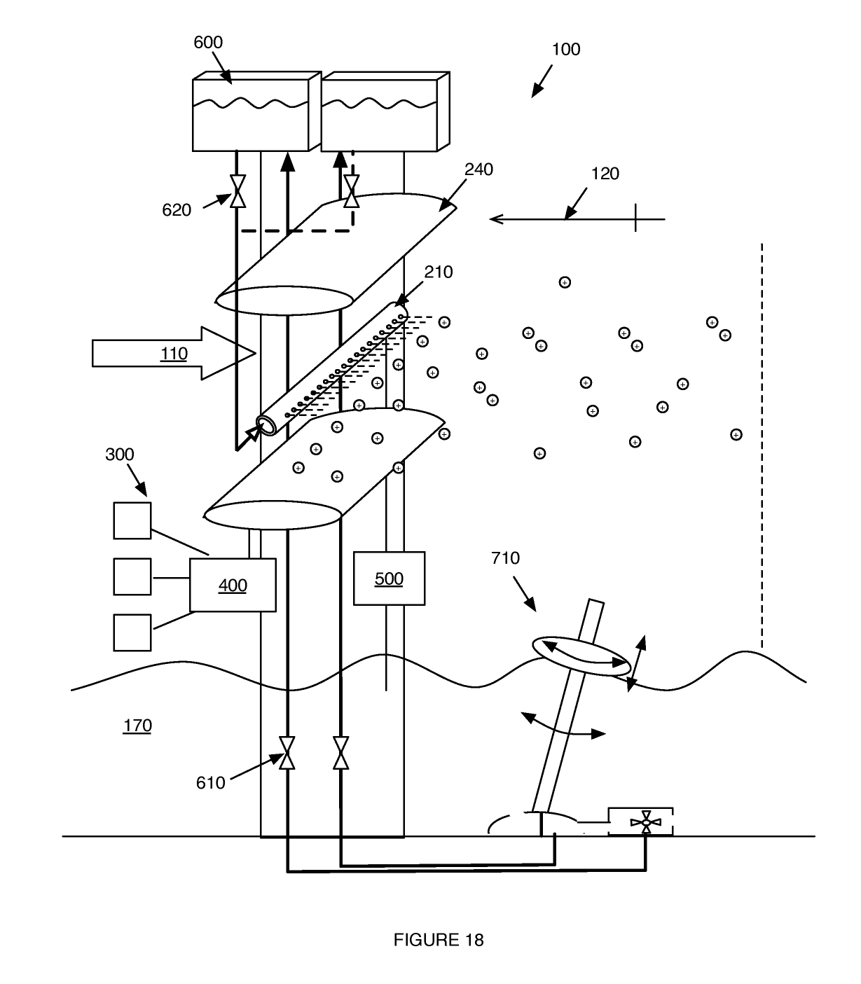

As shown in FIG. 18, the secondary manifold 210 can additionally include a supply valve 620, which functions to control carrier fluid flow from the reservoir 600 to the manifold lumen 214. The supply valve 620 can be operable between an open state that permits fluid flow from the reservoir 600 to the manifold 210, and a closed state that prevents fluid flow from the reservoir 600 to the manifold 210. The supply valve 620 can be active (e.g., controlled by the controller 400) or passive. The supply valve 620 can be biased closed or biased open. The supply valve 620 can be closed when the carrier fluid 140 level within the reservoir 600 falls below a first threshold level, when the carrier fluid 140 level within the other reservoirs 600 rise above a second threshold level, or in response to the occurrence of any other suitable condition. In some variants, the supply valve 620 can additionally function to electrically isolate the reservoir 600 from the manifold 210 (e.g., manifold lumen 214) when in the closed state. This can function to seal off an electrical path between the charged carrier fluid 140 (within the manifold lumen 214) and the carrier fluid source 170, such that the charged carrier fluid 140 does not short to the carrier fluid source 170. In these variants, the supply valve 620 can be operated in the closed state in response to reservoir 600 connection to the carrier fluid source 170. However, the supply valve 620 can be otherwise operated. Examples of the supply valve 620 include a ball valve, butterfly valve, disc valve, or any other suitable valve. The supply valve 620 can be made of plastic, ceramic, metal, or any other suitable material.

Carrier fluid 140 can be pumped, gravity fed, pressure-fed, or otherwise supplied from the reservoir 600 to the manifold 210. The carrier fluid 140 can be retained at atmospheric pressure (e.g., at the manifold 210 pressure), at an above atmospheric pressure, or at a below-atmospheric pressure within the reservoir 600. The carrier fluid 140 can be pressurized to the manifold 210 pressure by a pump 700 (e.g., active pump 700, wave pump 710, etc.), pressurized due to hydrostatic pressure, or otherwise pressurized to the manifold 210 pressure (e.g., working carrier fluid 140 pressure).

In one variation, the reservoir 600 is retained a predetermined distance above the manifold 210 (e.g., along a gravity vector), wherein the reservoir 600 gravity feeds the carrier fluid 140 to the manifold lumen 214. The distance between the manifold 210 and reservoir 600 can be static or adjustable. The reservoir 600 can be aligned with the manifold 210 along the gravity vector, offset from the manifold 210 along the gravity vector intersecting the manifold 210, or otherwise arranged relative to the manifold 210. In a specific example of this variation, the reservoir 600 is retained at least 3.5 meters above the manifold 210, to achieve a manifold 210 pressure of 10-15 psi. However, the reservoir 600 can be retained any suitable position relative to the manifold 210.

The reservoir 600 can additionally be fluidly connected to the carrier fluid source 170 by a source manifold 210. The source manifold 210 can be fluidly connected to the fluid inlet or any other suitable reservoir port. The source manifold 210 can additionally include a source valve 610 that functions to control carrier fluid 140 flow from the carrier fluid source 170 to the reservoir 600. The source valve 610 can be operable between an open state that permits fluid flow from the carrier fluid source 170 to the reservoir 600, and a closed state that prevents fluid flow from the carrier fluid source 170 to the reservoir 600. The source valve 610 can be active (e.g., controlled by the controller 400) or passive. The source valve 610 can be biased closed or biased open. The source valve 610 can be opened when the carrier fluid 140 level within the reservoir 600 falls below a first threshold level, when the carrier fluid 140 level within the other reservoirs 600 rise above a second threshold level, when the carrier fluid supply rate exceeds a threshold rate, or in response to the occurrence of any other suitable condition. In some variants, the source valve 610 can additionally function to electrically isolate the carrier fluid source 170 from the reservoir 600 (e.g., manifold lumen 214) when in the closed state. This can function to seal off an electrical path between the charged carrier fluid 140 (within the manifold lumen 214) and the carrier fluid source 170, such that the charged carrier fluid 140 does not short to the carrier fluid source 170. In these variants, the source valve 610 can be operated in the closed state in response to reservoir connection to the manifold 210. In one example, the source valve 610 can be operated in an opposing state to the supply valve 620 (e.g., open when the supply valve 620 is closed, closed when the supply valve 620 is open). However, the source valve 610 can be otherwise operated. Examples of the source valve 610 include a ball valve, butterfly valve, disc valve, or any other suitable valve. The source valve 610 can be made of plastic, ceramic, metal, or any other suitable material.

Carrier fluid 140 can be pumped, pressure-fed, collected, or otherwise supplied from the carrier fluid source 170 to the reservoir 600. In one variation, the EHD system 100 includes a pump 700 configured to pump carrier fluid 140 from the carrier fluid source 170 to the reservoir 600. The pump 700 can be a wave pump 710, the wave pump 710 can be that disclosed in U.S. application Ser. No. 14/138,677 filed 23 Dec. 2013, which is incorporated herein in its entirety by this reference. However, any other suitable wave pump 710 or other pump 700ing system can be used.

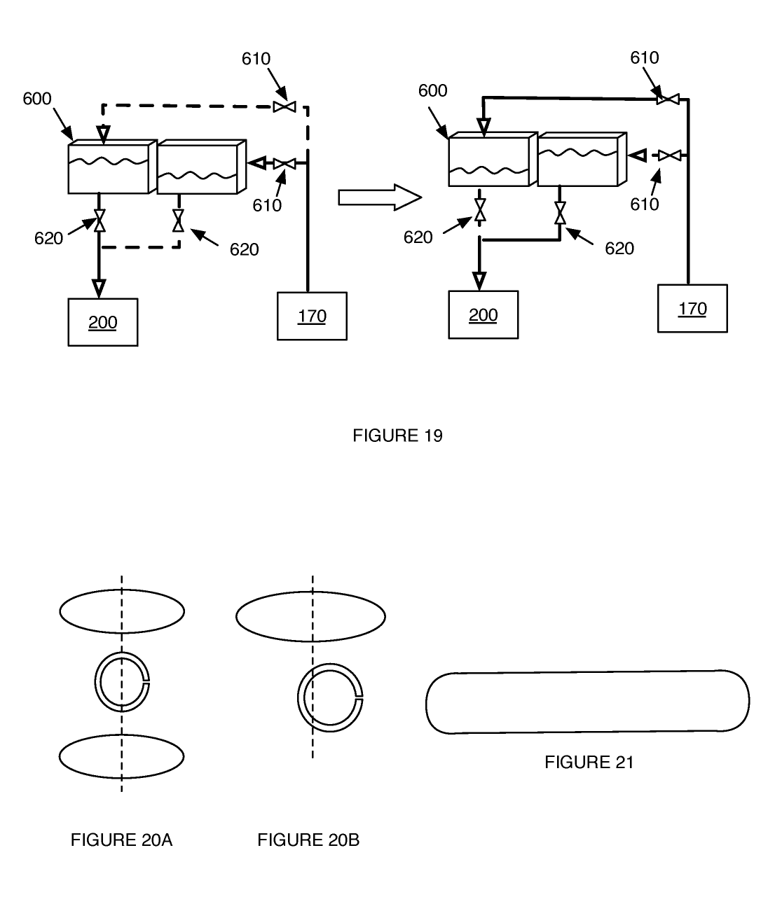

In one example of the EHD system 100 (shown in FIG. 19), the EHD system 100 includes multiple reservoirs 600 connected in parallel to the carrier fluid source 170 and the manifold 210. Each reservoir 600 includes a source valve 610 controlling fluid flow between the carrier fluid source 170 and the reservoir 600, and a supply valve 620 controlling fluid flow between the reservoir 600 and the manifold 210. The valves are controlled such that each reservoir 600 is only connected to the reservoir 600, the carrier fluid source 170, or neither at any given time. Different reservoirs 600 are sequentially connected to the manifold 210 (and disconnected from the carrier fluid source 170) based on the respective reservoir 600's fluid level. When the fluid level within the reservoir 600 connected to the manifold 210 falls below a threshold level, the reservoir 600 is disconnected from the manifold 210 and connected to the carrier fluid source 170. In this example, the reservoirs 600 are arranged at least a predetermined distance above the reservoir 600. In a specific example, the EHD system 100 is an offshore EHD system 100, the carrier fluid 140 is seawater, and carrier fluid 140 is pumped to the reservoirs 600 by one or more wave pumps 710. However, the EHD system 100 and reservoirs 600 can be otherwise configured.

### 2.7 Downstream and Upstream Collectors

The downstream collector of the EHD system 100 functions to collect particles of first polarity at a point downstream from charged particle generator 200. The downstream collector is preferably permanently electrically connected to the electrical load 500, but can alternatively be transiently connected or otherwise connected. Examples of the downstream collector include: the carrier fluid source 170, a mesh, or any other suitable conductive charge collector arranged downstream from the charged particle generator 200.

The upstream collector of the EHD system 100 functions to collect particles of the second polarity. The second polarity preferably opposes first polarity, but can alternatively be any other suitable polarity. The particles of the second polarity can be concurrently generated when the charged droplets 160 are released into the fluid stream no. In one example, the particles of the second polarity can be electrons left behind by charging the droplet to a positive polarity. However, the particles of the second polarity can be protons or any other suitable charge. The upstream collector can be a component of the charged particle generator 200 (e.g., the manifold 210, field shaper 240, etc.), the reservoir 600, the support 800, or be any other suitable EHD system 100 component. Alternatively, the upstream collector can be a separate component arranged proximal to or electrically connected to the charged particle generator 200.

### 3. Method of Operation

The method of operating an EHD system 100 can include: generating a first electric field; emitting droplets charged to a first polarity into the fluid stream 110, wherein the electric force generated by the first electric field opposes charged droplet 160 motion with the fluid stream 110; collecting charges of a second polarity at an upstream collector; collecting the charged droplets 160 at a downstream collector; and connecting an electrical load 500 between the upstream collector and downstream collector to extract electrical energy. The method can additionally include measuring an ambient environment parameter and dynamically adjusting EHD system operation based on the ambient environment parameter measurement. The method can additionally include selectively connecting and disconnecting different reservoirs 600 to the manifold 210, and selectively connecting and disconnecting different reservoirs 600 to a carrier fluid source 170.

The method functions to harvest electric energy from a fluid stream 110 (e.g., convert the kinetic energy of the fluid stream 110 into electric energy), but can alternatively perform any other suitable functionality. In particular, the drag force of the fluid stream no on the emitted charged droplets 160 substantially opposes the direction of the electrical force that the charged droplets 160 experience due to the first electric field; when the drag force is larger in magnitude than the electrical force, the fluid stream 110 performs work on the charged particles, increasing their potential energy which can be harvested at a downstream collector situated at a distal region relative to the charged particle generator 200. However, the method can operate in any other suitable manner.

The method is preferably performed by the EHD system 100 described above, but can alternatively be performed by any other suitable system. In one variation, the EHD system 100 can operate similar to the system described in U.S. application Ser. No. 14/299,970 filed 9 Jun. 2014, which is incorporated herein in its entirety by this reference. However, the EHD system 100 can function in any other suitable manner, and include any other suitable set of components.

Generating the first electric field functions to generate the working field 120. The first electric field can be generated due to charged droplet 160 flow along the fluid stream 110, by biasing the downstream collector at the first potential, by biasing an upstream electrode at the second potential, or generated in any other suitable manner.

Emitting droplets charged to a first polarity into the fluid stream 110 functions to emit charge carriers into the fluid stream 110, such that the fluid stream 110 can perform work against the first electric field. The first electric field preferably at least partially opposes charged droplet 160 movement along the fluid vector. The charged droplet 160 can be charged to less than 15% of its Rayleigh limit, between 2% and 10% of its Rayleigh limit, to 4% of its Rayleigh limit, 5% of its Rayleigh limit, 6% of its Rayleigh limit, or to any other suitable charge.

In a first variation, emitting droplets charged to a first polarity can include generating a polarized carrier fluid jet 150, wherein the tip of the carrier fluid jet 150 is biased at the first polarity. When the jet tip breaks up into discrete droplets, the droplets will be biased at the first polarity. Forming the carrier fluid jets 150 can include: receiving pressurized fluid within the manifold lumen 214, wherein pressurized fluid flow through the channels 220 to the ambient environment form Rayleigh jets, which eventually break up into drops at the jet tip. The fluid can be pressurized by hydrodynamic pressure, pressurized by a pump 700, or otherwise pressurized. The fluid pressure within the manifold 210 can be 10-15 psi, less than 20 psi, greater than 20 psi, less than 10 psi, or have any other suitable pressure. The fluid can be gravity fed, pumped, or otherwise supplied from the reservoir 600 to the manifold 210. The EHD system 100 (e.g., charging field generator, field shaper 240, etc.) can apply a charging field 130 to the carrier fluid jet tip and/or along the carrier fluid jet length. However, the charged droplets 160 can be otherwise generated.

In a second variation, emitting droplets charged to a first polarity can include generating an uncharged droplet 160 and charging the uncharged droplet 160 after formation. The uncharged droplet 160 can be generated by a carrier fluid jet 150, nozzle, or otherwise generated. Charging the uncharged droplet 160 can include applying a corona discharge to the droplet, leveraging capillary charged separation (e.g., charging the manifold exterior to a first polarity), or otherwise charging the uncharged droplet 160.

In a third variation, emitting droplets charged to a first polarity can include forming a Taylor cone to electrospray charged droplets 160 into the fluid stream 110. However, the charged droplets 160 can be otherwise created.

Although omitted for conciseness, the preferred embodiments include every combination and permutation of the various system components and the various method processes, wherein the method processes can be performed in any suitable order, sequentially or concurrently. As used herein, “approximately” or “substantially” can be within a predetermined tolerance threshold (e.g., 3%, 5%, 10%, etc.) of the specified or preferred value, configuration, or orientation; within a manufacturing tolerance; or within any other suitable degree of error.

As a person skilled in the art will recognize from the previous detailed description and from the figures and claims, modifications and changes can be made to the preferred embodiments of the invention without departing from the scope of this invention defined in the following claims.

We claim:

1. An electrohydrodynamic system configured to harvest electrical energy from a fluid stream flowing along a fluid vector, comprising:
a charged droplet generator configured to generate a first electric field, the charged droplet generator comprising:
a manifold defining: a manifold thickness, a downstream face, and a manifold lumen extending along a manifold longitudinal axis;
a plurality of channels defined through the manifold thickness along the downstream face, each channel of the plurality fluidly connecting the manifold lumen to an ambient environment external the manifold and configured to emit a droplet into the fluid stream, each channel of the plurality defining a channel length coextensive with the manifold thickness, the plurality of channels arranged in a row substantially parallel the manifold longitudinal axis; and
a field shaper configured to generate a substantially uniform charging field proximal the channels that charges the droplets to a single polarity, wherein an first electric force generated by the first electric field opposes charged droplet movement along the fluid vector;
a sensor configured to record a measurement of an ambient environment parameter; and
a controller electrically connected to the sensor and configured to adjust electrohydrodynamic system operation based on the measurement;
a load electrically connected to the charged droplet generator; and
a reservoir fluidly connected to the manifold lumen.

2. The system of claim 1, further comprising a first and second set of guard channels defined through the manifold thickness along the downstream face, wherein first and second set of guard channels are arranged in a circular segment centered about the plurality of channels, proximal a first and second end of the manifold, respectively.

3. The system of claim 1, further comprising a second field shaper, wherein the first field shaper, second field shaper, and manifold are arranged in parallel, wherein the manifold is substantially centered between the first and second field shapers.

4. The system of claim 3, wherein the first and second field shapers each define a central longitudinal axis and comprise an ellipsoid cross-section perpendicular the respective longitudinal axis.

5. The system of claim 1, wherein the manifold comprises an airfoil, wherein the downstream face comprises a trailing edge of the airfoil, wherein the plurality of orifices are arranged proximal the trailing edge.

6. The system of claim 1, wherein the reservoir is arranged above the manifold along a gravity vector.

7. The system of claim 6, further comprising a wave pump fluidly connected to the reservoir.

8. An electrohydrodynamic system configured to harvest electrical energy from a wind stream flowing along a wind vector, comprising:
a charged droplet generator configured to generate a first electric field, the charged droplet generator comprising:
a manifold defining a manifold lumen, a manifold thickness, and a plurality of channels extending through the manifold thickness along a downstream face of the manifold, wherein the plurality of channels are arranged in a row substantially parallel a manifold longitudinal axis, wherein each channel of the plurality is fluidly connected to the manifold lumen at a first channel end and is configured to emit droplets into the wind stream at a second channel end, wherein each channel of the plurality defines a channel length extending from the respective first channel end to the respective second channel end, wherein the channel length substantially coextensive with the manifold thickness; and
a field shaper configured to generate a substantially uniform charging field proximal the plurality of channels that charges the droplets to a single polarity, wherein the first electric field opposes charged droplet movement along the wind vector.

9. The system of claim 8, wherein the charged particle generator further comprises:
a sensor configured to record a measurement of an ambient environment parameter;
a controller configured to adjust electrohydrodynamic system operation based on the measurement; and
a load electrically connected to the charged droplet generator and configured to extract energy from charged particle flow against the electric field.

10. The system of claim 8, further comprising a second field shaper, wherein the first field shaper, second field shaper, and manifold are arranged in parallel, wherein the manifold is substantially centered between the first and second field shapers.

11. The system of claim 10, wherein the manifold is one of a plurality of substantially identical manifolds, wherein the plurality of manifolds are substantially evenly distributed between the first and second field shapers.

12. The system of claim 11, further comprising a set of secondary electrodes interspersed between adjacent manifolds, the secondary electrodes configured to homogenize the charging field proximal the second channel ends of each manifold of the plurality.

13. The system of claim 8, wherein the manifold comprises a single row of channels.

14. The system of claim 8, wherein each of the plurality of channels are linear channels and comprise a substantially constant circular cross-section perpendicular the respective channel length.

15. The system of claim 14, wherein a diameter of the second channel end of each channel of the plurality is less than 500 micrometers.

16. The system of claim 8, wherein the manifold comprises trailing edge features extending along the downstream face, parallel the manifold longitudinal axis.

17. The system of claim 8, further comprising a reservoir fluidly connected to the manifold lumen.

18. The system of claim 17, wherein a carrier fluid pressure within the manifold lumen is less than 15 psi.

19. The system of claim 18, wherein the reservoir is arranged above the manifold along a gravity vector and is configured to gravity feed a carrier fluid to the manifold lumen.

20. The system of claim 17, further comprising a valve arranged along a fluid path between the reservoir and manifold lumen, the valve operable between:
an open mode, wherein the valve fluidly connects the reservoir to the manifold lumen; and
a closed mode, wherein the valve electrically isolates the reservoir from the manifold lumen.
